(19) United States
(12) Patent Application Publication
(10) Pub. No.: US 2008/0233966 A1
(43) Pub. Date: Sep. 25, 2008

(54) Resource allocation apparatus and method in an orthogonal frequency division multiple access communication system

(75) Inventors: Jacob Scheim, Pardes Hanna (IL); Ophir Shabtay, Haifa (IL)

Correspondence Address: Zaretsky Patent Group PC, 17505 N 79th Ave, Ste 211, Glendale, AZ, 85308-8726, US

(73) Assignee: Comsys Communication & Signal Processing Ltd.

(21) Appl. No.: 12/052,551

(22) Filed: Mar. 20, 2008

Related U.S. Application Data
(60) Provisional application No. 60/896,372, filed on Mar. 22, 2007.

(51) Int. Cl. H04Q 7/22; H04B 7/00

(52) U.S. Cl. 455/452.1; 455/509

(57) ABSTRACT

A novel and useful method and system for resource allocation in OFDM communication systems. The mechanism reduces inter-cell interference by randomizing the inter-cell interference experienced in each cell. The mechanism effectively spreads the resource allocation in each cell in a random manner resulting in statistical-like inter-cell interference behavior. In many cases, use of the mechanism is sufficient to obviate the need for frequency planning between cells. A formula or hardware permutation machine is used to generate a random list of indices. The indices are then used to assign user data to the system resources. One or more parameters defining the random index generator at the transmitter are forwarded to the receiver to enable the local generation of an exact copy of the list of indices generated at the transmitter, thus enabling the DL and UL at the receiver while minimizing the required control channel signaling.

### REFERENCE TO PRIORITY APPLICATION

This application claims priority to U.S. Provisional Application Ser. No. 60/896,372, filed Mar. 22, 2007, entitled “Apparatus For And Method Of Resource Allocation in OFDMA Systems,” incorporated herein by reference in its entirety.

### FIELD OF THE INVENTION

The present invention relates generally to wireless communication systems and more particularly relates to a resource allocation apparatus and method for use in an orthogonal frequency division multiple access (OFDMA) communication system.

### BACKGROUND OF THE INVENTION

### 4G Wireless Communication Systems

Currently, wireless mobile communication systems are evolving towards their forth generation (i.e. 4G networks). The evolution to 4G promises an increased number of users as well as an increase in user bandwidths. Along with an increase in mobility, these new systems will demand a substantial increase in system requirements. 4G networks are being developed to accommodate the quality of service (QoS) and rate requirements set by forthcoming applications such as wireless broadband access, Multimedia Messaging Service (MMS), video chat, mobile television, high definition television content, Digital Video Broadcasting (DVB), conventional services such as voice (narrowband as well as wideband) and data and other streaming services.

Several objectives for 4G networks include a spectrally efficient system, high network capacity, a nominal mobile data rate of 100 Mbit/s, a nominal stationary data rate of 1 Gbit/s, smooth handoff across heterogeneous networks, global roaming across multiple networks and an all IP, packet switched network.

The principle baseband technologies to be used in 4G to help meet the above system goals include: (1) use of Orthogonal Division Multiple Access (OFDMA), a wireless technique proposed for WiMAX (IEEE 802.16e), WiFi (IEEE 802.11n), 3GPP-LTE and Ultra Mobile Broadband (UMB), to exploit the frequency selective channel property; (2) use of multiple-input multiple-output (MIMO) techniques in which multiple transmit and receive antennas are used for increasing system capacity and attaining high spectral efficiency (i.e. throughput, coverage, user rate, etc.); and (3) the use of turbo coding to minimize the required SNR at the receiver.

### MIMO

Multiple input, multiple output (MIMO) communication systems are known in the art.

The term MIMO refers to communication systems that employ an array of antennas at both the transmitter and the receiver. A system having a single transmit antenna and two or more receive antennas is commonly referred to as a receive diversity system. A system having multiple transmit antennas and a single receive antenna is commonly referred to as a transmit diversity system. Transmit diversity systems commonly use space-time codes such as an Alamouti codes. A system having multiple transmit and multiple receive antennas is referred to as a MIMO system.

Space-time block coding is a well known technique used in wireless communication systems to transmit multiple representations of a data stream across a number of antennas and to exploit the various received versions of the data to improve the reliability of data-transfer. Since the transmitted data traverses a potentially difficult environment with scattering, reflection, refraction, etc. in addition to corruption by thermal noise in the receiver, some representations of the received data will be in better shape than others. This redundancy results in a higher chance of being able to use one or more of the received representations of the data to correctly decode the received signal. Space-time coding combines all copies of the received signal in an optimal way so as to extract as much information from each copy as is possible.

There are two basic motivations for using multiple antennas in a wireless communications system. The first motivation is to gain an improvement in diversity, while the second motivation is to gain an improvement in achievable data rate/capacity. Multiple transmit antennas may be used to convey either dependent data streams (to increase immunity to fading or increase coverage) or independent data streams (to increase the capacity or data rate of the system).

A wideband MIMO system typically experiences frequency selective fading, which is characterized by different amounts of attenuation across the system bandwidth. This frequency selective fading causes inter-symbol interference (ISI), which is a phenomenon whereby each symbol in a received signal acts as distortion to subsequent symbols in the received signal. This distortion degrades performance by impacting the ability to correctly detect the received symbols.

### OFDM and OFDMA

Orthogonal Frequency Division Multiplexing (OFDM), a digital multi-carrier modulation scheme, is well known in the art. It uses a large number of closely spaced subcarriers that are orthogonal to each other. Each subcarrier is modulated with a conventional modulation scheme (e.g., quadrature amplitude modulation (QAM)) at a low symbol rate, maintaining data rates similar to conventional single carrier modulation schemes in the same bandwidth. The OFDM signals are typically generated using inverse fast Fourier transforms (IFFT) and fast Fourier transforms (FFT).

The primary advantage of OFDM over single-carrier schemes is its ability to cope with severe channel conditions, such as high frequency attenuation in copper wire, narrowband interference and frequency selective fading due to multipath, without the need for complex equalization filters in the receiver. Channel equalization is simplified because OFDM may be viewed as using many slowly modulated narrowband signals rather than one rapidly modulated wideband signal. The low symbol rate makes the use of a guard interval between symbols practicable, thereby making it possible to handle time spreading and eliminate intersymbol interference (ISI).

Orthogonal frequency division multiplexing (OFDM) may be used to combat ISI and/or for some other purposes. An OFDM system effectively partitions the overall system bandwidth into a number of (N_{F}) frequency subchannels. Each frequency subchannel is associated with a respective subcarrier on which data may be modulated. The frequency subchannels of the OFDM system may also experience frequency selective fading, depending on the characteristics (e.g., the multipath profile) of the propagation path between the transmit and receive antennas. With OFDM, the ISI due to frequency selective fading may be combated by repeating a portion of each OFDM symbol (i.e., appending a cyclic prefix to each OFDM symbol), as is known in the art.

For a MIMO system that employs OFDM (i.e. a MIMO-OFDM system), N_{F} frequency subchannels are available for each of the N_{S} spatial subchannels of a MIMO channel. Each frequency subchannel of each spatial subchannel may be referred to as a transmission channel. Up to N_{F}·N_{S} transmission channels may be available for use at any given moment for communication between the multiple-antenna base station and the multiple-antenna terminal.

Orthogonal Frequency Division Multiple Access (OFDMA) is a multi-user version of the OFDM digital modulation scheme. Multiple access is achieved in OFDMA by assigning subsets of subcarriers to individual users. This permits simultaneous low data rate transmission from/to several users. Adaptive user to subcarrier assignment is achieved based on feedback information about channel conditions. If the assignment is performed quickly enough, the robustness of OFDM to fast fading and narrowband co-channel interference is improved, thereby making it possible to achieve even better system spectral efficiency. In practice, a different number of subcarriers can be assigned to different users, to support differentiated Quality of Service (QoS), i.e. to control the data rate and error probability individually for each user.

A diagram illustrating an example prior art multiple access wireless communications system is shown in FIG. 1. The system, generally referenced 10, comprises a plurality of cells 14 (three in this example), each cell comprising a base station 12 in wireless communication with a plurality of user equipment (UE) or mobile stations (MS) 16. The base station transmits frames to the UEs which comprise control information and data. In addition, the three cells overlap each other by a certain amount. Due to the overlap in cell coverage, the normal transmissions within a cell can potentially cause interference in the other two cells.

An OFDMA system is considered an efficient modulation scheme which provides multiple access to a relatively large number of users with a relative simplicity by applying Fourier transform characteristics. In addition, at the receiver side, the OFDMA technology provides a relatively simple solution to the channel equalization problem. In operation, OFDMA implementation uses a fast-Fourier transform (FFT) algorithm which jointly modulates a large number of symbols over a large set of narrow band signals that are orthogonal to each other. The results of the FFT (in some cases inverse FFT or IFFT) form the basic transmission and reception element which is referred to as a symbol.

A block diagram illustrating a conventional OFDMA transceiver is shown in FIG. 2. The example OFDMA transceiver, generally referenced 20, comprises a transmit path that includes a symbol modulator block 21, serial to parallel conversion 22, IFFT block 24, parallel to serial conversion 26, cyclic prefix insertion 28, shaping circuit 30, digital to analog converter (DAC) 32, upconversion mixer 34, transmitter/receiver (T/R) switch 36 and antenna 38. The receive path comprises downconversion mixer 42, analog to digital converter (ADC) 44, timing clock 46, cyclic prefix removal 48, serial to parallel conversion 50, FFT block 52, parallel to serial conversion 53 and demodulator 54. The transceiver also comprises frequency reference (f_{c}) 40 and controller 56.

The conventional approach in wireless communications is to provide a duplex mode where the uplink (UL or upstream) and the downlink (DL or downstream) coexists with a separation in time and/or in frequency, i.e. Time Division Duplex (TDD) and Frequency Division Duplex (FDD), respectively. In addition, it is also convention to divide the communication signals into time frames of constant lengths. For example, a TDD system utilizes a time frame for the UL where another time frame serves the DL. Both DL and UL comprise reception and transmission symbols, respectively, while the DL and UL time frames may differ in duration and signal characteristics (i.e. they are non-symmetric). Another example of duplexing is FDD where the UL and DL are simultaneously transmitted. In this case, the UL and DL differ in the frequency bands and may also differ in their corresponding bandwidth.

In addition to the UL and DL signals, the communication signal may incorporate zero or more preambles or system specific signals used for example for initial synchronization of joining users or new cells to the system. These types of signals may broadcast system related information.

Currently, OFDMA systems provide an efficient modulation scheme which enables multiple-access of a relatively large number of simultaneous users with relative simplicity by utilizing the characteristics of the Fourier transform. In addition, at the receiver end, OFDMA technology provides a relative simple solution to channel equalization. In practice, OFDMA implementations use a fast-Fourier transform (FFT) to jointly modulate a large number of symbols over a large set of mutually orthogonal narrowband signals. Among the above mentioned benefits of the use of OFDMA, the combination of OFDMA and MIMO technologies naturally fit together.

An additional aspect of modern 4G cellular systems is the flexibility of system services. This flexibility includes, for example, the number of served terminals and their corresponding data traffic. Fourth generation cellular systems are considered to be dynamic both in terms of the number of mobile terminals served and the data traffic allocated to each mobile terminal. In this manner, some users may utilize low data traffic services such as voice calls in parallel with other users that may utilize high data rate applications such as audio/video conferencing, multicasting and mobile television broadcasting (to be introduced for fourth generation cellular systems).

The conventional approach in wireless communications is to provide a duplex mode where the uplink (UL) and the downlink (DL) operate simultaneously with separation in time and/or frequency, i.e. Time Division Duplex (TDD) and Frequency Division Duplex (FDD). In another conventional framework, the communication signals are divided into time frames of constant length. In a TDD system, for example, separate time periods (i.e. slots) are allocated for the UL and DL. The UL and DL time slots may differ in duration and signal characteristics (i.e. non-symmetric).

A diagram illustrating the frame structure of a conventional OFDMA frame is shown in FIG. 3. The frame structure shown represents a conventional approach to the structure of the control message portion of the frame. The example system comprises a specific frame allocation having five resources, labeled R1-R5, assigned to users or groups of users indicated with u-ID1 through u-ID5, respectively. The control message comprises five consecutive elements each including the u-ID and the all other resource associated control information (e.g., resource assignment and associated transfer format). Note that, the control message may also be spread over the control message physical resource using an interleaver or randomized mapping function.

Each frame, generally referenced 60, in a multiple access communication system includes a signaling or control portion 62 where the system informs users (via the DL) or users inform the system (via the UL) on the transfer format used in the remainder of the frame. This signaling part may be considered as control signaling which is essential for the correct demultiplexing and demodulation of the payload data portion of the frame. Typically, the control signaling is placed with fixed timing with respect to the frame boundaries, usually near the beginning of the frame in a frame header comprising a plurality of symbols 69. Further, since the content of the control message is essential to the correct demodulation of the data part of the frame 64, which comprises the resources 68 assigned to users, the control message is usually encoded using strong error correction codes (ECC) in order to provide a high level of reliability. For additional reliability, the control message may also use a robust transmission scheme (i.e. using any combination of modulation, beam forming, transmit diversity or repetition techniques) which should increase the reliability of detection.

The control message incorporated within the frame may serve a variable number of users. In this case, it is divided into several sub-messages 66 where each sub-message corresponds to a specific user or a group of users. The information incorporated in the sub-message helps the user (or group of users) to identify (1) the system resources scheduled for the user(s) and (2) the data transferring format to permit the correct demodulation of the associated resource.

A diagram illustrating the structure of the control message portion 130 of a conventional OFDMA frame is shown in FIG. 4. A more detailed description can be found in the 3rd Generation Partnership Project (3GPP), Technical Specification Group Radio Access Network, PHY Layer aspects for Evolved Universal Terrestrial Radio Access (E-UTRA) (3GPP TR 25.814 V7.1.0) and Evolved Universal Terrestrial Radio Access (E-UTRA) Physical Channel and Modulation (Release 8) (TS 36.211 v8.1.0), both of which are incorporated herein by reference.

The downlink control signaling comprises, for example, scheduling information for downlink data transmission, scheduling grants for uplink transmission and ACK/NAK indications in response to uplink transmission. Downlink scheduling information is used to inform the UE as to how to process downlink data. Typical information signaled to a UE scheduled to receive user data is shown in FIG. 4.

With reference to FIG. 4, the control message comprises an indication 132 of the u-ID or group of u-IDs assigned resources in that frame. Resource related information may include (1) an indication or reference to the particular resource assigned 134 (e.g., time, frequency, space, etc. or any combination thereof) and (2) the time duration 136 the assignment is valid. The data transferring format information may comprise MIMO mode related data 138 to indicate that the content depends on particular MIMO schemes indicated as well as the modulation scheme 140 utilized for the assigned resource (e.g., QPSK, 16QAM, 64QAM), payload size 142 and HARQ information 144 to indicate the hybrid ARQ process the current transmission is addressing. All the information related to the resource assignment and transfer format is typically optimized and may utilize look up tables, formulas or other techniques to reduce signaling overhead.

Uplink scheduling grants are used to assign resources to UEs for uplink data transmission. The modulation and coding scheme used for the uplink transmission is implicitly given by the resource assignment and the transport format. Examples of the information signaled to a UE receiving an uplink scheduling grant includes: the u-ID indicating the UE or group of UEs for which the grant is intended, a resource assignment indicating which uplink resources the UE is permitted to use for uplink data transmission, assignment duration indicating the duration for which the assignment is valid and one or more transmission parameters comprising uplink transmission parameters the UE should use (e.g., modulation scheme, payload size, MIMO related information, etc.).

In both user specific association and group-based association, the control sub-message part of the frame 62 (FIG. 3) comprises information representing the identity of the user or group of users (referred to as u-ID in both cases). The u-ID element of information indicates an existing assignment of a corresponding resource(s) 68 to the u-ID.

An approach commonly taken in fourth generation cellular systems is that system resources (i.e. time, frequency, space (layer)) are allocated dynamically to the users served within a cell. In the time domain, an OFDMA symbol defines the basic resource element or resource unit. In the frequency domain, a single subcarrier defines a resource element. A spatial resource element, termed a layer, is defined by a single antenna stream. An alternative definition to spatial resource element is termed ‘virtual antenna.’ A virtual antenna employs a set of physical antennas with corresponding pre-coding processing to separate the received signal in the spatial domain into layers (i.e. each layer having a corresponding pre-coding process).

A resource block (RB) is formed by grouping resource elements within the above mentioned dimensions. In the time domain, a resource block may be defined in the granularity of: symbols, number of symbols (slots), number of slots (frames), etc. In the frequency domain, a resource block may be defined with the granularity of sub-carriers, a set of sub-carriers (i.e. clusters) or a set of clusters (i.e. a clusters-group). A spatial resource may refer to an antenna or a group of antennas. It is important to note that in all time/frequency and space, the resource block definition is appropriate for both (1) a ‘localized collection’ of consecutive symbols/slots/frames or sub-carriers/clusters for time or frequency, respectively; or (2) a ‘distributed collection’ wherein the time/frequency/space elements are not necessarily consecutive.

A block diagram illustrating an example prior art multi-user OFDM system is shown in FIG. 5. The system, generally referenced 350, comprises a base station (BS) 352 in communication with a user equipment (UE) device 358. The base station comprises an OFDM transceiver such as shown in FIG. 2 and a resource allocation block 356. The UE comprises an OFDM transceiver 360 and subchannel selection block 362.

In the base station, the resource allocation block uses channel information obtained through feedback channels from all mobile users. The resource allocation scheme generated by block 356 is forwarded to the OFDM transmitter. The transmitter then selects different amounts of data for the users to form an OFDM symbol. Typically, the resource allocation scheme is updated as channel information is collected. At the UE, the subchannel selection block processes the resource allocation data 364 sent by the BS to properly decode the information units 366 sent over the wireless link.

The problem of resource allocation can be stated as a problem of how to optimally allocate resources (i.e. power and rate) across a set of parallel and independent dimensions in frequency, time (fading state) and space (multiple antennas) given channel conditions with fading or InterSymbol Interference (ISI), and the assumption that all the transmitters and receivers have complete Channel State Information (CSI).

Resource allocation poses a complex problem for the following reasons. First, a large number of users being served with numerous types of services define a complex control-signaling problem, since each user needs to be signaled with a corresponding control signal to specify the corresponding resources allocated to it. It follows that in this case, the control signaling increases with the number of users and services. Secondly, from a system level perspective, resources allocated in a specific cell may cause interference to other cell transmissions (see FIG. 1). This is the case for both the UL and DL, independently as well as for TDD and FDD, independently. The interference is created due to the ‘reuse principle’ applied in all cellular systems which allows distant cells (i.e. not directly neighboring cells) to allocate (i.e. reuse) the same resources.

One prior art approach to solving the resource allocation problem is to deploy a cellular network using network planning (i.e. frequency or time planning). In a network planned system, the resources allocated to each cell are carefully designed and coordinated. This is beneficial in terms of performance since the system may optimize the level of inter-cell interference while sacrificing system complexity. Network planning, however, is considered impractical due to maintenance issues. For example, simply upgrading the system with new cells may require a complete network redesign.

Other prior art approaches to reduce inter-cell interference include implementing receivers with interference cancellation algorithms to reduce the level of inter-cell interference experienced at user terminals. The algorithms required, however, are typically complex and are costly in terms of consuming relatively large computing resources.

Thus, there is a need for a resource allocation mechanism that is suitable for use in cellular systems with or without frequency planning. The mechanism should be able to allocate resources to users while reducing the potential for inter-cell interference caused by cell reuse of system resources. In addition, the resource allocation mechanism should be relatively simple to implement both in terms of control channel signaling and implementation complexity, without sacrificing system complexity or requiring a large amount of computing resources.

### SUMMARY OF THE INVENTION

Accordingly, the present invention provides a novel and useful method and system for resource allocation in OFDM communication systems. The resource allocation mechanism is suitable for systems both with and without frequency planning. The mechanism functions to reduce inter-cell interference by randomization of the inter-cell interference experienced in each cell. The mechanism effectively randomly spreads the resources in each cell which results in statistical-like inter-cell interference behavior. In many cases, use of the mechanism is sufficient to obviate the need for frequency planning between cells. In addition, the present invention provides a frequency diverse allocation method for the single user case.

The resource allocation mechanism of the present invention is operative to randomly generate a list of indices that is used to randomly allocate system resources at both the transmitter and the receiver. The list of indices can be generated using any suitable means. Several examples of generating the list of indices are presented and include use of a formula and use of generating hardware. Regardless of the means used to generate the list of indices, a key feature of the present invention is the capability of generating the same list of indices at both the transmitter and receiver.

In one embodiment, a formula is used to generate the list of indices. In this case, the parameters of the formula generated at the transmitter and sufficient to reproduce the list of indices are forwarded to the receiver. At the receiver, the received parameters are used to generate an exact local copy of the list of indices originally generated at the transmitter. The list is then used to map the resource allocation to the DL and UL.

In another embodiment, a linear feedback shift register (LFSR) is used as a permutation machine to generate the list of indices. In this case, the parameters of the LFSR used at the transmitter and sufficient to reproduce the list of indices are forwarded to the receiver. At the receiver, a local LFSR is configured with the received parameters and used to generate an exact local copy of the list of indices originally generated at the transmitter. The list is then used to map the resource allocation to the DL and UL.

The resulting output of the generating means is a randomized list of indices that is then used to allocate the actual resources. Randomizing the indices used functions to randomly spread the allocations over the resource range. Spreading the allocations randomly over the resource range provides several benefits including: (1) enabling the allocation of resources that are most adapted to the channel conditions, which is desirable in systems such as MIMO systems; and (2) providing an increase in frequency diversity by spreading resources over the entire available bandwidth (advantageous in channels with a large number of reflections).

Advantages of the resource allocation mechanism of the present invention include: (1) the index generating apparatus (formula, LFSR, etc.) is relatively simple to implement in terms of the required control signaling overhead, which is minimal; (2) the cost of implementing the index generating means is very low, requiring minimal additional hardware and/or computing resources; (3) the index generating means is operative to create a resource allocation permutation that reduces inter-cell interference level in the cellular system thus minimizing the number of collisions between cells; (4) the index generating means uses cell specific parameters to configure different permutations for different cells; and (5) the index generating means supports the case of multiple users each requiring allocations from different portions of system resources.

The resource allocation mechanism of the present invention is suitable for use in many types of wireless communication systems. For example, the mechanism is applicable to broadband wireless access (BWA) systems and cellular communication systems, particularly OFDM based systems. An example of a broadband wireless access system the mechanism of the present invention is applicable to is the well known WiMAX wireless communication standard. The mechanism of the invention is also applicable to one of the third-generation (3G) mobile phone technologies known as 3GPP-LTE, Universal Mobile Telecommunications System (UMTS), Code Division Multiple Access (CDMA), Enhanced Data rates for GSM Evolution (EDGE) and Wireless Local Area Network (WLAN) wireless communication systems. The invention is also applicable to fourth generation (4G) mobile technologies, Digital Video Broadcasting (DVB) standards, Ultra Wideband (UWB), Ultra Mobile Broadband (UMB) and IEEE 802.11g/a.

Many aspects of the invention described herein may be constructed as software objects that execute in embedded devices as firmware, software objects that execute as part of a software application on either an embedded or non-embedded computer system running a real-time operating system such as Windows mobile, WinCE, Symbian, OSE, Embedded LINUX, etc., or non-real time operating systems such as Windows, UNIX, LINUX, etc., or as soft core realized HDL circuits embodied in an Application Specific Integrated Circuit (ASIC) or Field Programmable Gate Array (FPGA), or as functionally equivalent discrete hardware components.

There is thus provided in accordance with the present invention, a method of allocating resources for communication with a plurality of user equipment (UE) in a wireless communications system, the method comprising the step of generating a randomized resource allocation permutation, assigning resources for communication with the plurality of UE in accordance with the resource allocation permutation and communicating information to the plurality of UE to enable duplication of the resource allocation permutation therein.

There is also provided in accordance with the present invention, a method of allocating resources for communication with a plurality of user equipment (UE) for use in a base station in a cellular communications system, the method comprising the step of receiving a request to transmit, in response to the request, generating a randomized resource allocation based on a permutation generated in accordance with the cellular system, assigning resources for communication with the plurality of UE in accordance with the resource allocation permutation, communicating information to the plurality of UE to enable duplication of the resource allocation permutation therein and transmitting to the plurality of UE wherein data for each UE is allocated in accordance with the resource allocation permutation.

There is further provided in accordance with the present invention, a method of allocating resources for communication with a base station for use in a user equipment (UE) in a wireless communications system, the method comprising the step of sending a resource request to the base station, receiving from the base station, in response to the resource request, parameters to enable duplication of a randomized resource allocation permutation generated by the base station and used to assign resources for communication in the wireless communications system and transmitting to the base station wherein data is allocated in accordance with the resource allocation permutation.

There is also provided in accordance with the present invention, a resource allocation apparatus for use in a cellular communications system comprising an index generator operative to generate a randomized resource allocation permutation and a resource allocation module operative to assign resources for communication with a plurality of UE in accordance with the resource allocation permutation and to communicate information to the plurality of UE thereby enabling duplication of the resource allocation permutation therein.

There is further provided in accordance with the present invention, a communications device comprising a transmitter, a receiver, a media access control (MAC), a baseband processor coupled to the transmitter, the receiver and the MAC, a resource allocation unit for communicating with a base station, the resource allocation unit operative to send a resource request to the base station, receive from the base station, in response to the resource request, parameters to enable duplication of a randomized resource allocation permutation generated by the base station and used to assign resources for communication therebetween and transmitting to the base station wherein data is allocated in accordance with the resource allocation permutation.

### BRIEF DESCRIPTION OF THE DRAWINGS

The invention is herein described, by way of example only, with reference to the accompanying drawings, wherein:

FIG. 1 is a diagram illustrating an example prior art multiple access wireless communications system;

FIG. 2 is a block diagram illustrating a conventional OFDMA transceiver;

FIG. 3 is a diagram illustrating the frame structure of a conventional OFDMA frame;

FIG. 4 is a diagram illustrating the structure of the control message portion of a conventional OFDMA frame;

FIG. 5 is a block diagram illustrating an example prior art multi-user OFDM system;

FIG. 6 is a general block diagram illustrating an example radio incorporating the resource allocation mechanism of the present invention;

FIG. 7 is a general block diagram illustrating a mobile station incorporating the resource allocation mechanism of the present invention;

FIG. 8 is a general system block diagram illustrating the logical and physical mapping and allocation of system resources;

FIG. 9 is a block diagram illustrating an example 8-bit wide linear feedback shift register (LFSR);

FIG. 10 is a system level block diagram illustrating the allocation of resources for both the DL and UL;

FIG. 11 is a diagram illustrating the structure of an example control message of the present invention;

FIG. 12 is a diagram illustrating an example network resource plan;

FIG. 13 is a flow diagram illustrating the base station DL resource allocation method of the present invention;

FIG. 14 is a flow diagram illustrating the user equipment DL resource allocation method of the present invention;

FIG. 15 is a diagram illustrating an example protocol message flow for the DL;

FIG. 16 is a flow diagram illustrating the base station UL resource allocation method of the present invention;

FIG. 17 is a flow diagram illustrating the user equipment UL resource allocation method of the present invention;

FIG. 18 is a diagram illustrating an example protocol message flow for the UL;

FIG. 19 is a diagram illustrating the generation of an index number using interleaved bits;

FIG. 20 is a resource allocation diagram illustrating a first example sequence allocation;

FIG. 21 is a resource allocation diagram illustrating a first example sequence allocation where the index is shifted;

FIG. 22 is a resource allocation diagram illustrating a first example sequence allocation where the sequence is shifted;

FIG. 23 is a resource allocation diagram illustrating a second example sequence allocation;

FIG. 24 is a diagram illustrating an original resource allocation;

FIG. 25 is a diagram illustrating the resource allocation of FIG. 24 after flipped up-down renumbering;

FIG. 26 is a diagram illustrating the resource allocation of FIG. 24 after diagonal renumbering; and

FIG. 27 is a diagram illustrating the resource allocation of FIG. 24 after flipped left-right renumbering.

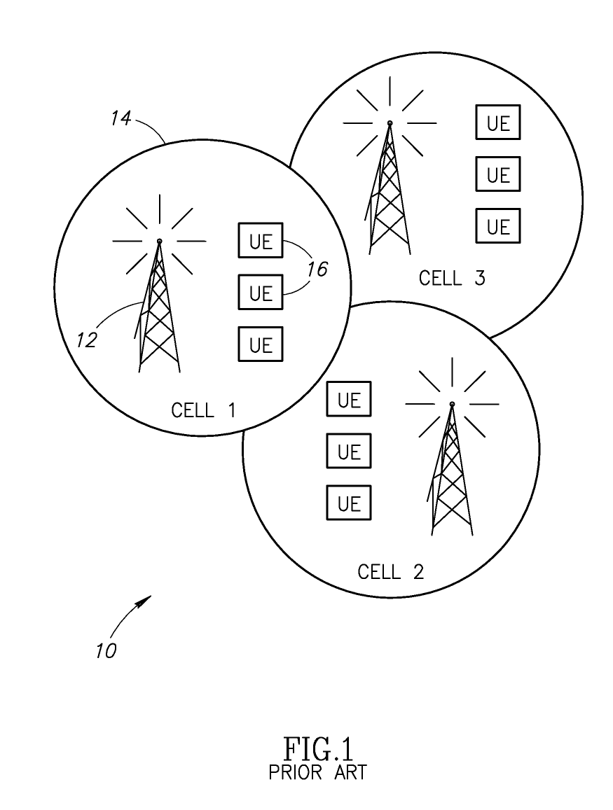

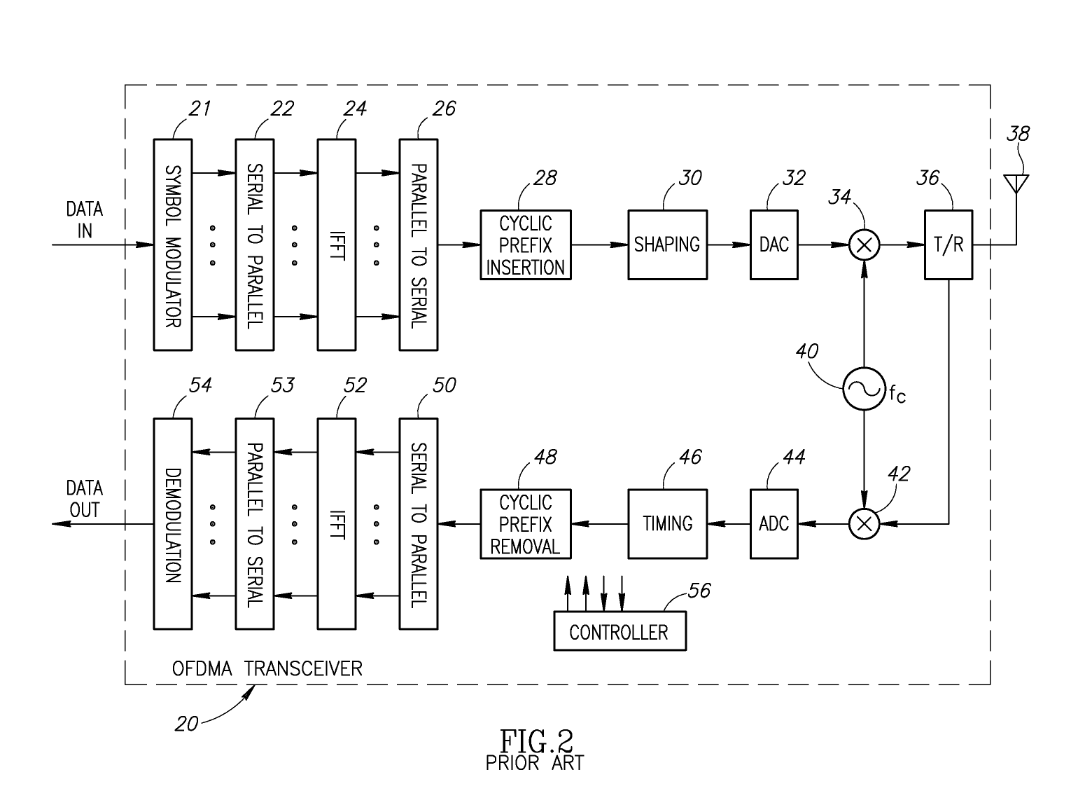

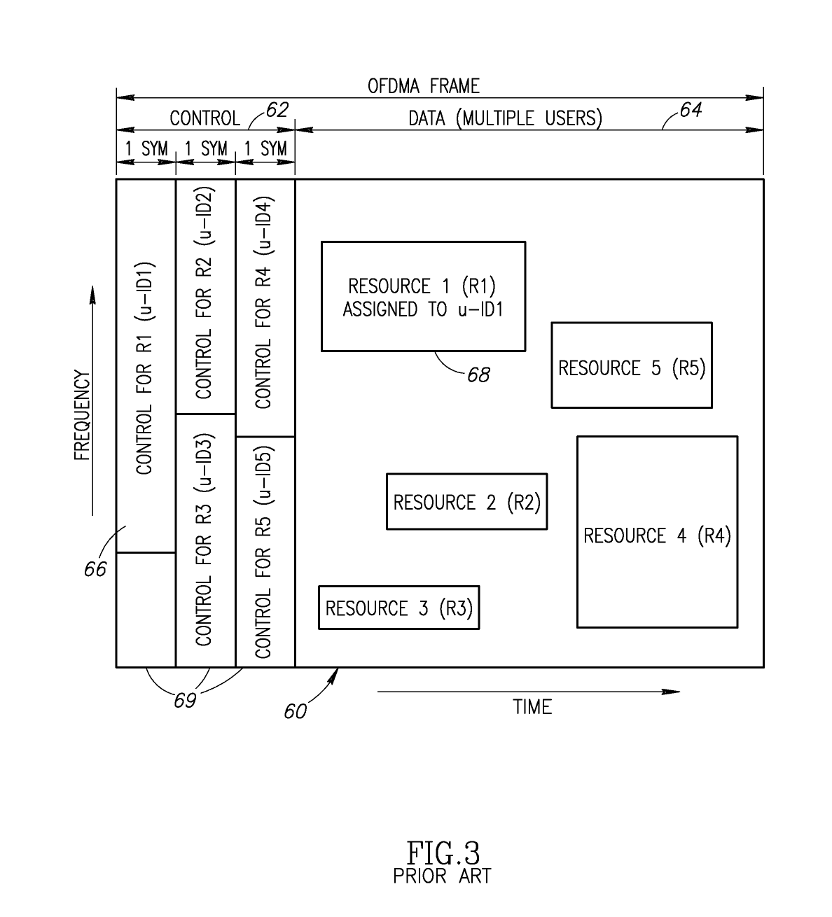

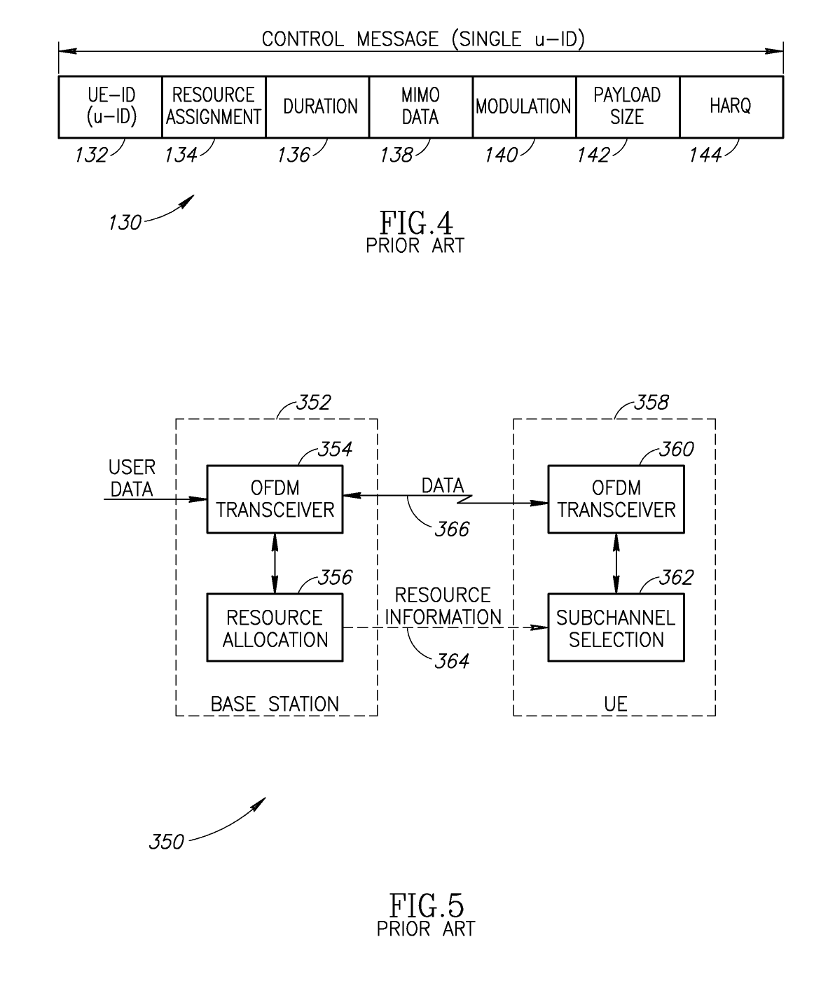

### DETAILED DESCRIPTION OF THE INVENTION

### Notation Used Throughout

The following notation is used throughout this document.

| Term | Definition |
|---|---|
| AAA | Authentication Authorization and Accounting |
| AC | Alternating Current |
| ADC | Analog to Digital Converter |
| ARQ | Automatic Repeat Request |
| ASIC | Application Specific Integrated Circuit |
| AVI | Audio Video Interface |
| BMP | Windows Bitmap |
| BWA | Broadband Wireless Access |
| CDMA | Code Division Multiple Access |
| CP | Cyclic Prefix |
| CPU | Central Processing Unit |
| DAC | Digital to analog Converter |
| DC | Direct Current |
| DL | Downlink |
| DRAM | Dynamic Random Access Memory |
| DVB | Digital Video Broadcast |
| ECC | Error Correction Code |
| EDGE | Enhanced Data rates for GSM Evolution |
| EEPROM | Electrically Erasable Programmable Read Only Memory |
| EPROM | Erasable Programmable Read Only Memory |
| EVDO | Evolution-Data Optimized |
| FDD | Frequency Division Duplex |
| FEC | Forward Error Correction |
| FEM | Front End Module |
| FFT | Fast Fourier Transform |
| FM | Frequency Modulation |
| FPGA | Field Programmable Gate Array |
| GPRS | General Packet Radio Service |
| GPS | Global Positioning Satellite |
| GSM | Global System for Mobile Communication |
| HARQ | Hybrid Automatic Repeat Request |
| HDL | Hardware Description Language |
| ID | Identification |
| IEEE | Institute of Electrical and Electronic Engineers |
| IFFT | Inverse Fast Fourier Transform |
| ISI | Intersymbol Interference |
| JPG | Joint Photographic Experts Group |
| KPI | Key Performance Indicators |
| LAN | Local Area Network |
| LSB | Least Significant Bit |
| MAC | Media Access Control |
| MIMO | Multiple In Multiple Out |
| MME | Mobility Management Entity |
| MP3 | MPEG-1 Audio Layer 3 |
| MPG | Moving Picture Experts Group |
| MS | Mobile Station |
| MSB | Most Significant Bit |
| OFDMA | Orthogonal Frequency Division Multiple Access |
| OSI | Open System Interconnect |
| PC | Personal Computer |
| PCI | Peripheral Component Interconnect |
| PDA | Personal Digital Assistant |
| QAM | Quadrature Amplitude Modulation |
| QPSK | Quadrature Phase Shift Keying |
| RAM | Random Access Memory |
| RAN | Radio Access Network |
| RAT | Radio Access Technology |
| RF | Radio Frequency |
| ROM | Read Only Memory |
| SDIO | Secure Digital Input/Output |
| SFN | Single Frequency Network |
| SIM | Subscriber Identity Module |
| SPI | Serial Peripheral Interface |
| SRAM | Static Read Only Memory |
| TDD | Time Division Duplex |
| TV | Television |
| UE | User Equipment |
| u-ID | User (or group of users) Identification code |
| UL | Uplink |
| UMB | Ultra Mobile Broadband |
| UMTS | Universal Mobile Telecommunications System |
| USB | Universal Serial Bus |
| UTRA | Universal Terrestrial Radio Access |
| UWB | Ultra Wideband |
| WCDMA | Wideband Code Division Multiple Access |
| WiFi | Wireless Fidelity |
| WiMAX | Worldwide Interoperability for Microwave Access |
| WiMedia | Radio platform for UWB |
| WLAN | Wireless Local Area Network |
| WMA | Windows Media Audio |
| WMV | Windows Media Video |
| WPAN | Wireless Personal Area Network |

### Detailed Description of the Invention

Accordingly, the present invention provides a novel and useful method and system for resource allocation in OFDM communication systems. The resource allocation mechanism is suitable for systems both with and without frequency planning. The mechanism functions to reduce inter-cell interference by randomization of the inter-cell interference experienced in each cell. The mechanism effectively randomly spreads the resources in each cell which results in statistical-like inter-cell interference behavior. In many cases, use of the mechanism is sufficient to obviate the need for frequency planning between cells.

The resource allocation mechanism of the present invention is randomly generates a list of indices that is used to randomly allocate system resources at both the transmitter and the receiver. Randomizing the indices used functions to randomly spread the allocations over the resource range. The list of indices can be generated, for example, using a formula or generating hardware (e.g., LFSR). Regardless of the means used to generate the list of indices, the list of indices generated at the transmitter is duplicated at the receiver, thus enabling the DL and UL at the receiver.

The resource allocation mechanism of the present invention is suitable for use in many types of wireless communication systems. For example, the mechanism is applicable to broadband wireless access (BWA) systems and cellular communication systems, particularly OFDM (and OFDMA), single carrier frequency division multiple access (SC-FDMA), linear precoded OFDMA (LP-OFDMA) and other wideband signaling based systems. An example of a broadband wireless access system the mechanism of the present invention is applicable to is the well known WiMAX wireless communication standard. The mechanism of the invention is also applicable to one of the third-generation (3G) mobile phone technologies known as Universal Mobile Telecommunications System (UMTS), 3GPP Long Term Evolution (3GPP-LTE), Code Division Multiple Access (CDMA), Enhanced Data rates for GSM Evolution (EDGE) and Wireless Local Area Network (WLAN) wireless communication systems. The invention is also applicable to fourth generation (4G) mobile technologies, Digital Video Broadcasting (DVB) standards, Ultra Wideband (UWB), Ultra Mobile Wideband (UMB) and IEEE 802.11n/g/a.

To aid in illustrating the principles of the present invention, the resource allocation mechanism is presented in the context of an OFDMA communications system. It is not intended that the scope of the invention be limited to the examples presented herein. One skilled in the art can apply the principles of the present invention to numerous other types of communication systems as well (wireless and non-wireless) without departing from the scope of the invention.

Note that throughout this document, the term communications transceiver or device is defined as any apparatus or mechanism adapted to transmit, receive or transmit and receive information through a medium. The communications device or communications transceiver may be adapted to communicate over any suitable medium, including wireless or wired media. Examples of wireless media include RF, infrared, optical, microwave, UWB, Bluetooth, WiMAX, GSM, EDGE, UMTS, WCDMA, 3GPP-LTE, CDMA-2000, EVDO, EVDV, UMB, WiFi, or any other broadband medium, radio access technology (RAT), etc. Examples of wired media include twisted pair, coaxial, optical fiber, any wired interface (e.g., USB, Firewire, Ethernet, etc.). The terms communications channel, link and cable are used interchangeably. The terms mobile station (MS), user equipment (UE) and subscriber unit (SU) are defined as all user equipment circuitry and associated software needed for communication with a network such as a RAN. The terms mobile station, user equipment and subscriber unit are also intended to denote other devices including, but not limited to, a multimedia player, mobile communication device, cellular phone, node in a broadband wireless access (BWA) network, smartphone, PDA, wireless LAN (WLAN) and Bluetooth device. Although a mobile station, user equipment or subscriber unit are normally intended to be used in motion or while halted at unspecified points but, the terms as used herein also refers to devices fixed in their location. The term u-ID (i.e. user ID) refers to information representing the identity of a user or group of users.

The word ‘exemplary’ is used herein to mean ‘serving as an example, instance, or illustration.’ Any embodiment described herein as ‘exemplary’ is not necessarily to be construed as preferred or advantageous over other embodiments.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.) and/or other content widely identified as multimedia. The user input means is typically formed of one or more manually operated switches, buttons, wheels or other user input means. Examples of multimedia devices include pocket sized personal digital assistants (PDAs), personal media player/recorders, cellular telephones, handheld devices, and the like.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Radio Incorporating the Resource Allocation Mechanism

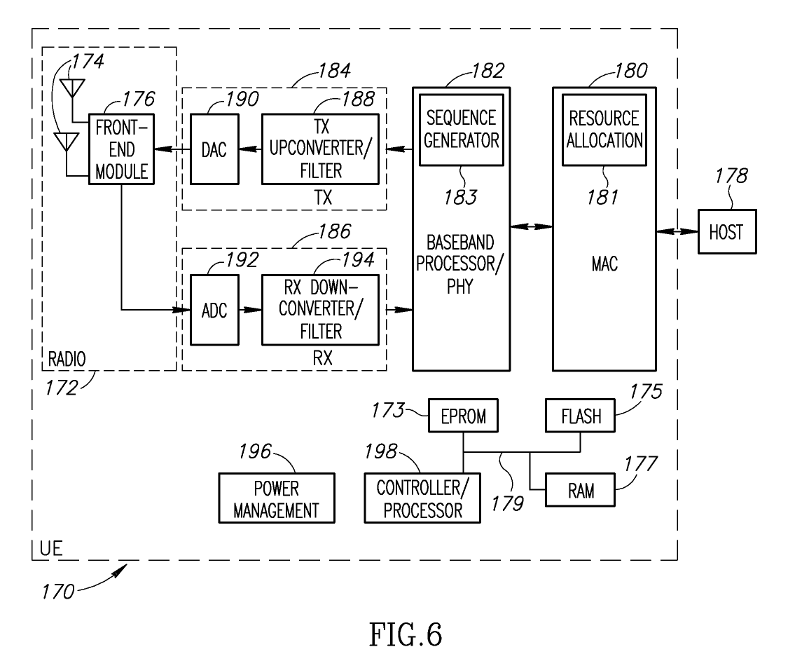

A general block diagram illustrating an example UE incorporating the resource allocation mechanism of the present invention is shown in FIG. 6. The UE, generally referenced 170, comprises a radio block 172 comprising RF front end module (FEM) 176 coupled to one or more antennas 174 (typically at least two in BWA systems), transmitter block 184 and dual receiver block 186 coupled to the FEM 176 and baseband processor/PHY 182, MAC 180, power management block 196, a controller/processor 198 coupled to ROM memory 173, Flash 175 and RAM 177. The transmitter block 184 comprises TX upconversion and filtering block 188 and DAC 190. The receiver block 186 comprises ADC block 192 and RX downconversion and filtering block 194.

A host interface (not shown) functions to interface the UE via the MAC to a host entity 178. The host may comprise any suitable computing device such as a PDA, laptop computer, desktop computer, handheld telecommunications device, etc. The host interface may be adapted to communicate with the host in any manner. Typically, the host interface is adapted to communicate via a standard interface including, but not limited to, PCI, CardBus, USB, SDIO, SDI, etc.

The media access controller (MAC) 180 is operative to provide Layer 2 functionality. The main services and functions of the MAC sublayer includes mapping between logical and transport channels, multiplexing and demultiplexing of radio link control (RLC) PDUs belonging to one or different radio bearers into/from transport blocks (TB) delivered to/from the physical layer on transport channels, traffic volume measurement reporting, error correction through HARQ, priority handling between logical channels of one UE, priority handling between UEs by means of dynamic scheduling and transport format selection. The baseband processor/PHY module 182 performs modulation and demodulation of data (i.e. OFDM in the case of WLAN 802.11n/a/g, WiMAX, UWB, etc. capable radio). The baseband processor also handles the transmission and reception of frames to and from the TX and RX, respectively. Analog to digital (ADC) and digital to analog (DAC) conversion are performed in the receiver and transmitter, respectively. The FEM 176, coupled to antenna 174, performs radio frequency (RF) processing including filtering, optional down-conversion and up-conversion and amplification of the RF signal.

In accordance with the present invention, the resource allocation mechanism of the present invention is implemented in the radio. Depending on the particular implementation, the resource allocation mechanism including the sequence generator (i.e. index generator) may be implemented in the baseband processor/PHY block 182, the MAC 180, as a task adapted to execute on the controller 198, or any combination of the above. For illustration purposes only, the resource allocation mechanism is shown implemented in the MAC (block 181) while the sequence generator (block 183) is implemented in the PHY. It is appreciated that the resource allocation mechanism may be implemented in other components of the radio as well without departing from the scope of the invention. In the case where the mechanism of the invention (i.e. the sequence generator and/or the entire mechanism) is implemented as a task executed on the processor/controller, the programming code for implementing the mechanism may reside in memories 173, 175 or 177 within the radio or in internal memory within the processor/controller 198 itself. Note also that the mechanism may be performed entirely in hardware, software or a combination of hardware and software. Alternatively, the mechanism may be implemented entirely in the host or a portion implemented in the host and a portion in the MAC.

In addition, the invention may be implemented in a mobility management entity (MME), the MAC or a combination thereof. The MME is the control plane entity that manages the attachment to the network, handover procedures, the authentication of the user equipment and interfaces the RAN for the creation of relevant radio bearers.

The processor/controller 198 in the radio is coupled to also comprise a, flash memory 175, static random access memory (SRAM) 177 and electrical erasable programmable read only memory (EEPROM) 173. Note that DRAM may be used in place of static RAM. The controller 198 is operative to provide management, administration and control to the MAC, baseband processor, PHY and TX, RX modules. The controller is also in communication with the Flash, SRAM and EEPROM memories via a memory bus 179 or via a single bus (not shown) shared by all the modules and memory devices.

### Mobile Station Incorporating the Resource Allocation Mechanism

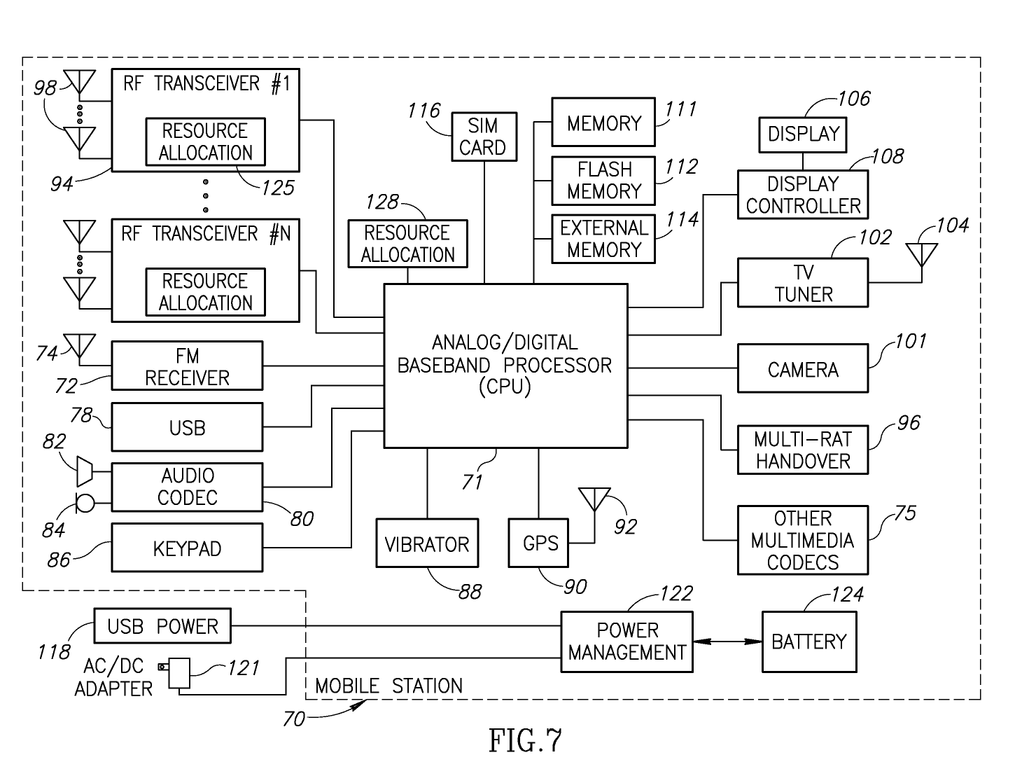

A general block diagram illustrating a mobile station incorporating the resource allocation mechanism of the present invention is shown in FIG. 7. Note that the mobile station (also referred to as user equipment) may comprise any suitable wired or wireless device such as multimedia player, mobile communication device, cellular phone, smartphone, PDA, Bluetooth device, etc. For illustration purposes only, the device is shown as a mobile station. Note that this example is not intended to limit the scope of the invention as the resource allocation mechanism of the present invention can be implemented in a wide variety of communication devices.

The mobile station, generally referenced 70, comprises a baseband processor or CPU 71 having analog and digital portions. The MS may comprise a plurality of RF transceivers 94 and associated antennas 98. RF transceivers for the basic cellular link and any number of other wireless standards and RATs may be included. Examples include, but are not limited to, Global System for Mobile Communication (GSM)/GPRS/EDGE 3G; CDMA; WiMAX for providing WiMAX wireless connectivity when within the range of a WiMAX wireless network using OFDMA techniques; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; 60G device; UWB; etc. One or more of the RF transceivers may comprise an additional a plurality of antennas to provide antenna diversity which yields improved radio performance. The mobile station may also comprise internal RAM and ROM memory 111, Flash memory 112 and external memory 114.

Several user interface devices include microphone(s) 84, speaker(s) 82 and associated audio codec 80 or other multimedia codecs 75, a keypad for entering dialing digits 86, vibrator 88 for alerting a user, camera and related circuitry 101, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM receiver 72 and antenna 74 provide the user the ability to listen to FM broadcasts. SIM card 116 provides the interface to a user's SIM card for storing user data such as address book entries, etc. Note that the SIM card shown is intended to represent any type of smart card used for holding user related information such as identity and contact information, Authentication Authorization and Accounting (AAA), profile information, etc. Different standards use different names, for example, SIM for GSM, USIM for UMTS and ISIM for IMS and LTE.

The mobile station comprises resource allocation blocks 125 which may be implemented in any number of the RF transceivers 94. Alternatively, or in addition to, the resource allocation block 128 may be implemented as a task executed by the baseband processor 71. The resource allocation blocks 125, 128 are adapted to implement the resource allocation mechanism of the present invention as described in more detail infra. In operation, the resource allocation blocks may be implemented as hardware, software or as a combination of hardware and software. Implemented as a software task, the program code operative to implement the resource allocation mechanism of the present invention is stored in one or more memories 111, 112 or 114 or local memories within the baseband processor.

Portable power is provided by the battery 124 coupled to power management circuitry 122. External power is provided via USB power 118 or an AC/DC adapter 121 connected to the battery management circuitry which is operative to manage the charging and discharging of the battery 124.

### Resource Allocation Mechanism

The present invention achieves the goal of providing a resource allocation scheme that functions to reduce inter-cell interference by randomizing the indices used to allocate resources in each cell. The randomization of the indices reduces the inter-cell interference experienced in each cell by effectively spreading the resources in each cell over the entire resource range in a random manner which results in statistical-like inter-cell interference behavior.

The mechanism employs a sequence generator for generating the random sequence of indices. The sequence generator may comprise any suitable random number generating means. Two examples for indicating the randomized resource allocation include a formula or generating apparatus, both of this may be implemented in hardware, software or a combination thereof. In accordance with the invention, the formula or generating apparatus is operative to generate a list of indices used to indicate the allocation of system resources. The list of indices generated at the transmitter is made available to the receiver using relatively simple control channel signaling.

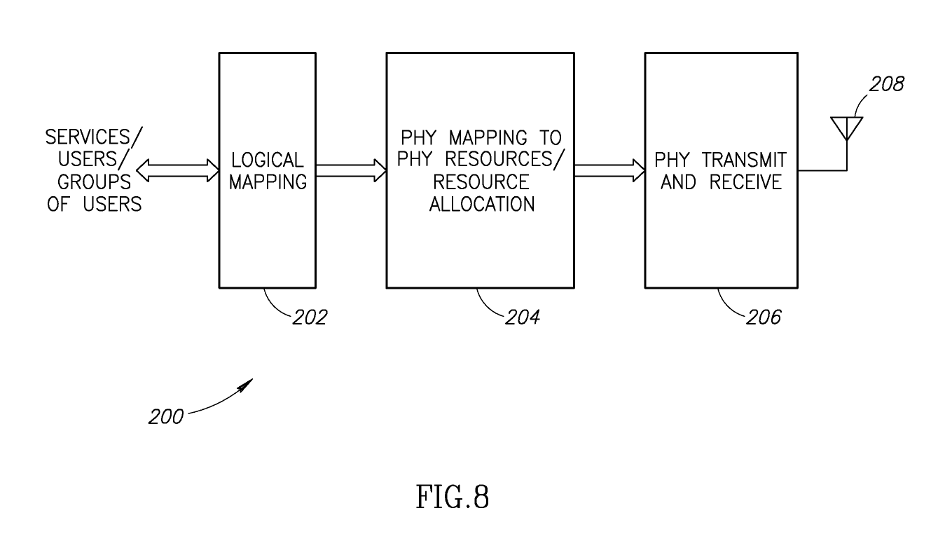

A general system block diagram illustrating the logical and physical mapping and allocation of system resources is shown in FIG. 8. The system, generally referenced 200, comprises a logical mapping block 202, PHY mapping block 204 and a PHY transmit and receive block 206 coupled to antenna 208. In operation, the logical mapping unit analyses the incoming and outgoing traffic for users and services in a cell. Input parameters include, for example, the number of users and associated services, etc. Output parameters include, for example, user allocation requirements, the number of resource blocks or PDUs per user or service, etc. The analysis process may comprise a large set of parameters such as Quality of Service (QoS), channel quality, etc.

The results of the logical mapping analysis performed by block 202 is input to PHY mapping block 204 which functions to map all the services and users onto system resources in accordance with the analysis results of the logical mapping block 202. The PHY mapping entity generates the resource assignment which eventually is applied to the PHY transmitter or receiver accordingly. In the example embodiment presented herein, the resource allocation mechanism of the invention is implemented in the PHY mapping block 204, typically in the MAC portion. The sequence generator may be implemented in the MAC or, more typically, in the PHY. The allocations are used to construct the OFDM frame in the transmit direction or to select sub-channels in the receive direction. Note that the resource allocations described herein may be static or dynamic, for users and/or for cells. Further, the allocations may be completely non-overlapping.

The resource allocation pattern (also referred to as a permutation) may be classified as either regular or random (i.e. pseudorandom). Preferable, the resulting random permutation provides a large set of randomized patterns having a low cross correlation with each other. In the case of random permutations, in order to achieve randomized patterns having a low cross correlation, the formula or generating apparatus generates a sufficiently large number of permutations wherein each is utilized by separated cells.

In the case of a permutation formula, one example technique to efficiently generate a permutation formula is to use a polynomial wherein a different set of parameters is used in each cell. In particular, linear polynomials can permute the entire resource block or a portion thereof using only two parameters: slope and offset, each pair of which is unique per cell. Note that use of linear permutations tends to result in a regular type of permutation. Higher-order polynomials may be used, however, to span the resource range where the calculations can be made using modulo operations. In an alternative embodiment, the permutation formula uses a lookup table (LUT) rather than a formula. One advantage of using a LUT is that new permutations may be added relatively easily.

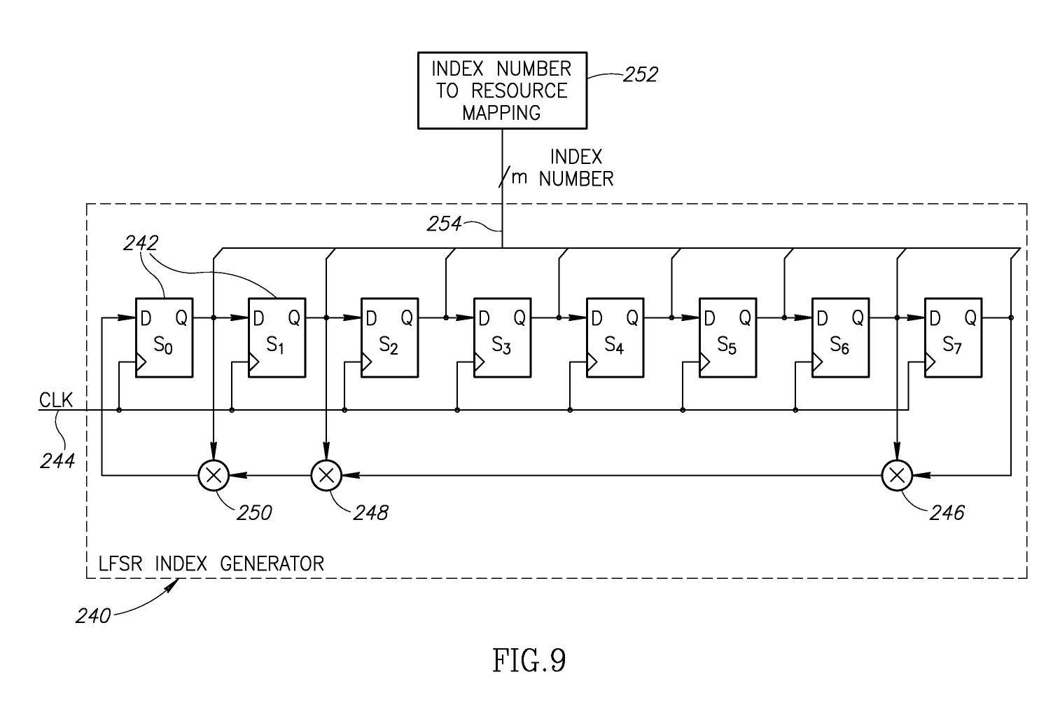

In the case of a generating apparatus, one example technique to efficiently generate a sequence (i.e. permutation) is to use a linear feedback shift register (LFSR) machine as the basic permutation machine. A block diagram illustrating an example 8-bit wide linear feedback shift register (LFSR) is shown in FIG. 9. The LFSR, generally referenced 240, comprises a plurality of series coupled flip-flops 242 having a common clock and with feedback taps at positions 1, 2, 7 and 8. XOR gates 246, 248, 250 function to combine the feedback taps to generate a feedback signal that is fed into the input of the first flip-flop. The m-bit index number generated 254 (m=8 in this example) is input to an index to resource mapping block 252 which functions to convert the raw LFSR generated index number into a resource assignment.

In this embodiment, the state of the LFSR is thus used as an index generator to a resource element of the entire group of cell resource blocks. An LFSR with m bits ensures the pseudo-random generation of all the indices from 1 to 2^{m}−1. The LFSR based index generator provides a very efficient scheme with respect to other techniques for generating random indices (e.g., bit-map based index generation).

In accordance with the invention, a similar LFSR machine is employed at the receiver for calculating the corresponding permutation. The parameters required by the receiver to exactly regenerate the index sequence are sent using simple control channel signaling to the receiver. For example, only two parameters are required to duplicate the sequence generated by the LFSR: the initial state and the length of the allocation (i.e. the length of the list of indices). Thus, the invention provides a relatively simple mechanism for the receiver to duplicate the sequence generated at the transmitter used to assign resources, when compared with other implementations, e.g., look up table based schemes.

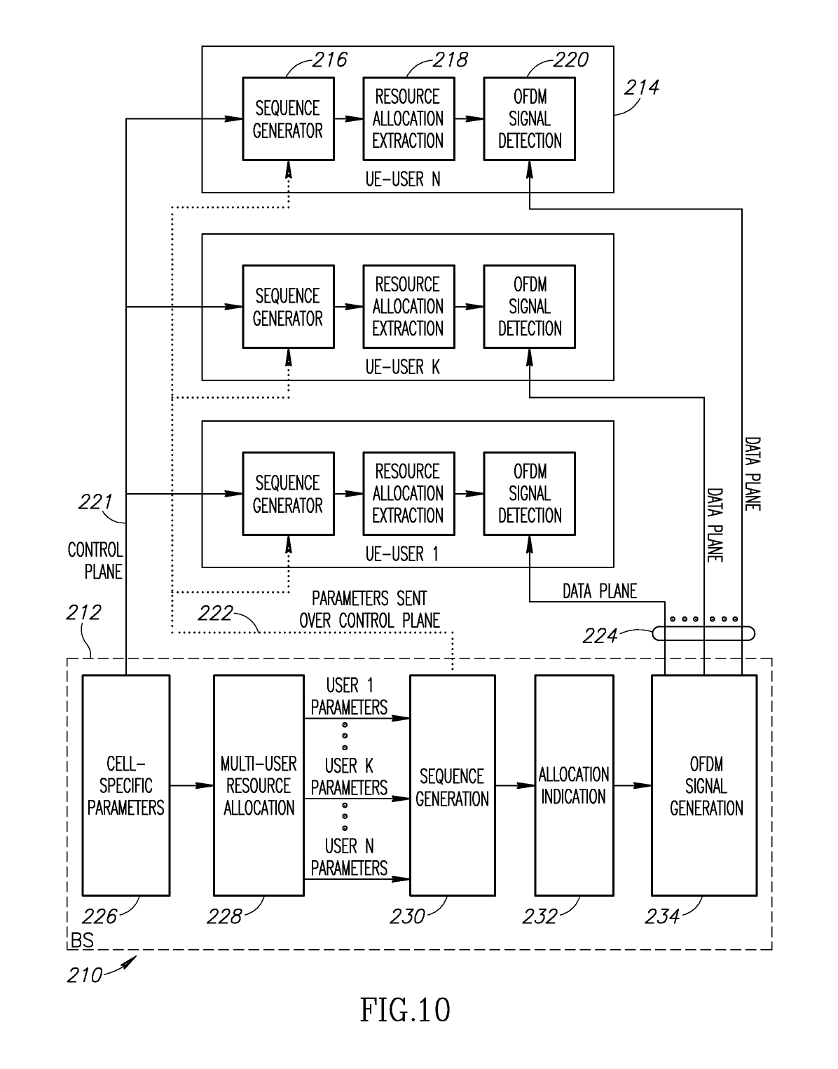

A system level block diagram illustrating the allocation of resources for both the DL and UL in the receiver and transmitter is shown in FIG. 10. The system, generally referenced 210, comprises a base station (BS) 212 and a plurality N of user equipment (UE) devices 214. The base station comprises a multi-user resource allocation block 228 adapted to receive one or more cell-specific parameters 226 and to output parameters for users 1 to N, a sequence generator 230, allocation indication block 232 and an OFDM signal generation block 234. Each user equipment device comprises a sequence generator 216 (equivalent to the sequence generator 230 in the base station), resource allocation extraction block 218 and OFDM signal detection block 220.

In operation, the resource allocation block 228 functions to generate parameters for users 1 to N based on the particular parameters and other criteria specific to that cell. The parameters for each user are input to the sequence generator 230 which functions to generate the basic randomized list of indices (i.e. permutation or sequence). The list of indices is forwarded to the allocation block 232 which builds the frame in accordance with the list. An OFDM signal is then generated from the completed frames and then transmitted to the UEs over the data plane 224.

The parameters needed by the user equipment devices to replicate the sequence pattern (permutation) is sent over the control plane 221 (as indicated by dotted arrow 222). The OFDM frames generated by the OFDM signal generation block 234 are effectively recovered by the OFDM signal detection blocks 220 in each user equipment device (as indicated by the solid data plane arrows 224). The sequence generator 216 in each UE is configured with the received parameters and a sequence identical to that generated at the transmitter is generated by the receiver. Each user has unique sequence as indicated by the control plane. The sequence is then used to extract the sub-channel information from the frame via block 218. The extracted information is then detected and decoded via block 220.

Note that in addition to a cell-ID based sequence generator selection other ways of setting the generator parameters may be used. In one embodiment, the information used to configure the cell specific sequence generator is based on other cell-specific parameters (e.g., as is the case in GSM frequency hopping sequence generation). Alternatively, the cell generating apparatus setup is broadcast or signaled using the control channel. In addition, the setup of the generating apparatus (i.e. index generator) may be initiated either in the receiver or the transmitter, e.g., as is the case in the DL and UL, respectively.

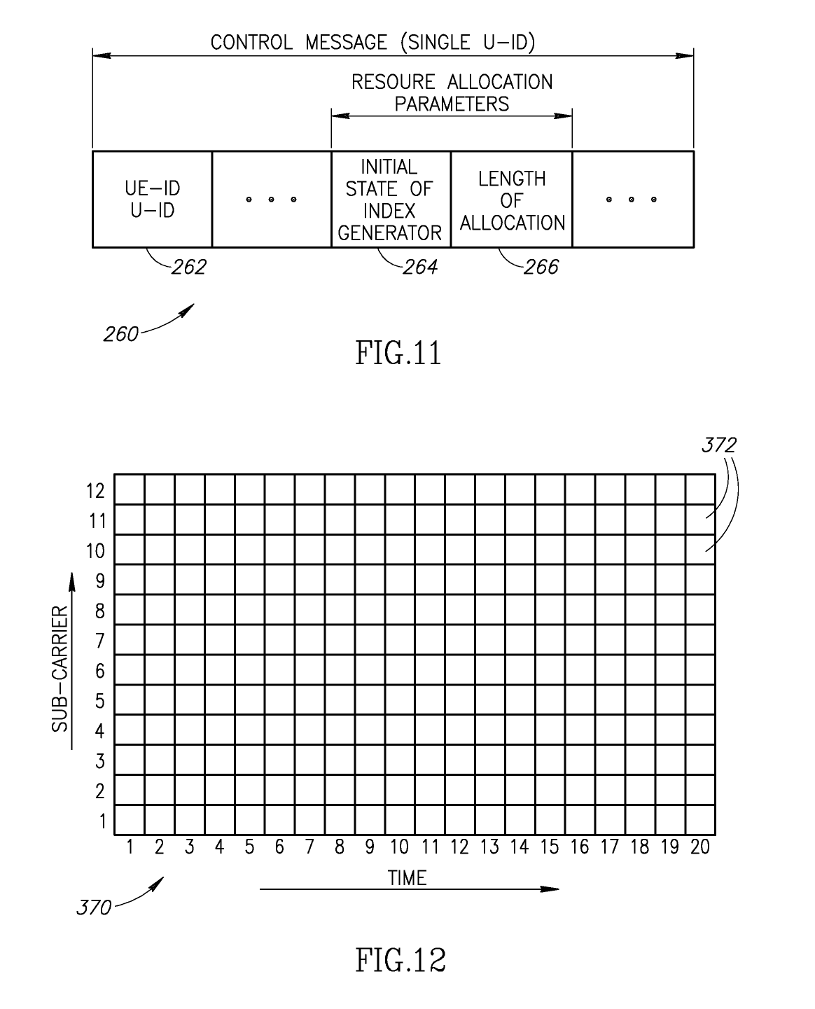

A diagram illustrating the structure of an example control message of the present invention is shown in FIG. 11. The control message, generally referenced 260, comprises, inter alia, any and all UE-ID (or u-ID) information 262 associated with that frame and resource allocation related fields 264, 266. The resource allocation related fields are used to convey the information required by the receiver to replicate the allocation sequence generated at the transmitter. In this example, consider the transmitter and receiver employing either a formula or an LFSR as the index generator used to generate the allocation sequence. In this case, the resource allocation parameters include an initial state of the index generator field 264 and a length of the allocation field 266 (i.e. the length of the index list).

In accordance with the invention, a unique permutation formula used in a specific cell is identified using one or more system parameters known to both the cell site and the user equipment as shown in FIG. 11. For example, in some cases, systems may use a cell-ID which uniquely identifies a cell for all practical purposes. The existence and use of this parameter as an indicator to a corresponding permutation vector for the specific cell is beneficial in terms of control signaling reduction and optimization. In addition, the network may use the same permutation formula for a group of cells in order to implement a broadcasting service. The transition from the cell specific to the group of cells permutation may be performed adaptively.

Consider a deployed system with resource elements, either for the DL and UL, as illustrated by the example network resource plan diagram shown in FIG. 12. For clarity sake, the allocation diagram 370 refers to the time-frequency (or time-subchannel) domain while the spatial dimension can be considered a trivial extension for the present invention. Further, the plurality of squares 372 in diagram 370 represent a logical view of the cell resources. The physical mapping of the allocation diagram may be localized or distributed.

The number of frequency and time domain resources is denoted by N_{f}^{RB} and Nₜ^{RB}, respectively. For illustration purposes only, the resource allocation mechanism is described using the system resources shown in FIG. 12. The cell resources in this example comprise a grid of N_{f}^{RB}=12 sub-channels by Nₜ^{RB}=20 time slots resulting in a total of 12×20=240 resource blocks. Note that this type of cell resource can be found in the 3GPP-LTE framework.

Consider in this example an 8-stage (i.e. 8-bit) long conventional LFSR 240 (FIG. 9) which spans a sequence of 255 numbers (i.e. indices to cell resources) cyclically, which is sufficient for allocating 240 resource blocks. It is important to note that different lengths of LFSR yield different numbers of unique available sequences. This does not include, however, internal shifts within a certain sequence, as described in more detail infra. As an example, it is well-known from the theory of finite field arithmetic that 16 unique sequences exist for an LFSR of length m=8 and that 18 unique sequences exist for an LFSR of length m=7.

The permutation machine is operative to generate an output comprising indices (i.e. numbers) to the resource blocks. The resource block numbers (i.e. list of indices), however, may or may not be randomized. In the case where the resource block numbers (i.e. index number bits) are not randomized, the most significant bit (MSB) represents the left-most bit and the least significant bit (LSB) represents the right-most bit. To randomize the numbers, the index number bits are further manipulated in various ways, as described infra. Even in the case of using the index generator to output a randomized list of indices, further randomization of the index numbers may be achieved by applying additional processing to the index numbers.

The index generating machine is operative to allocate all the cell resources randomly without producing any self-interference between intra-cell allocations. In addition, the randomized allocation generated at the transmitter is conveyed to the receiver via control channel signaling. Each receiver (i.e. user) receives the necessary parameters to duplicate the randomized allocation locally at the receiver. In one embodiment, two parameters are required to be sent which indicate the user-specific allocated resources: (1) the initial state of the index generator and (2) the length of allocation, for a total of 8+8=16-bits. Alternatively, the two parameters include (1) the initial state of the index generator and (2) the final state of the index generator (e.g., the LFSR), for a total of 16-bits. In a third alternative, the parameters include any other signaling (i.e. parameters, etc.) that represent the permutation machine associated with a specific receiver and that is able to duplicate the randomized allocation at the receiver.

Thus, from the parameters sent via from the transmitter, the receiver has knowledge of the initial state of the index generator (e.g., formula or LFSR). Note that the parameters can be sent by direct signaling (via the control channel) or by indirect calculation. For example, consider the index generator comprising an LFSR. In this case, the LFSR at the receiver is configured with the initial state parameter. The LFSR is clocked and the randomized allocation is generated until the stopping condition is fulfilled (i.e. the length is reached or the final state is reached). Note that the rolling operation can be achieved by calculation. The stopping condition can be signaled to the receiver, for an example, as the number of rolls or a final LFSR state. All the states of the LFSR during the LFSR calculations are used for further mapping and processing (e.g., as entry to another defined permutation).

At the end of the permutation calculation process the list of indices may be an unordered list (i.e. in terms of an ascending series). In cases where this is undesirable, the mechanism is operative to reorder the list of indices in an ascending order or any other desired order pattern. The ordering of the generated randomized list of indices is performed at both the base station and the user terminal in order that the final resource assignment remains the same. Further, it is noted that reordering does not affect the inter-cell and intra-cell interferences and is implementation specific.

Different users served by the same cell can be allocated different sections of the generated sequence. Allocating different users with consecutive sections of the generated sequence ensures that there is no overlapping between the physical resources associated with different users served by the cell of interest.

It is noted that the above resource allocation scheme can be combined with other resource allocation algorithms which use frequency planning. For example, the cell resources may be divided into several equal or non-equal portions. These portions divide the cell resources in the frequency domain, time domain or spatial domain, or any combination thereof. For some of the cell resource portions, the cell uses the above-mentioned scheme to allocated resources. For the remaining portions, the cell may use a non-randomized approach for allocating the same resources to a group of users. In addition, different portions of the cell resources can be used for different services. For example, some portions of the cell resources can be used for single user multiple access while simultaneously other portions of the cell resources are used for broadcasting.

In addition to the user specific allocation scheme presented supra, it is important to note that the resource allocation scheme can also serve a group of users or may be used on a per service basis. For example, the resource allocation may be used as a broadcasting channel or cell common control channel serving all users attached to the cell.

Note that the resource allocation mechanism presented herein can also be applied to MIMO resource allocation in a straight forward manner. A MIMO setup can be effectively considered as an increase in the number of resource blocks of each cell. Other than having to handle an increase in the number of resource blocks, the mechanism for allocating resources in a MIMO based system is the same as described herein, being suitable for both UL and DL transmissions, independently.

Note further that the resource allocation mechanism can be scaled with the system bandwidth. In one embodiment, the resource allocation algorithm used in one band is duplicated on the adjacent band. In another embodiment, the adjacent band is considered to be a new cell by identifying it with a new generating sequence.

Note also that the allocation mechanism can be adapted to systems employing interference cancellation receivers by tuning multiple access allocations to optimize the canceling capability of the receivers. One example of such an allocation is static allocation. In another example, the physical resource blocks are allocated to multiple cells or users.

The allocation mechanism as described herein is applicable to data, control or a combination of both data and control. Further, the invention is suitable for use in (1) cell specific allocations wherein each cell has its own corresponding permutation; (2) groups of cells wherein all cells use the same permutation so as, for example, to provide better cell coverage for those users within the groups of cells; and (2) applications where the entire network uses the same resources an transmit the same data, e.g., single frequency networks (SFNs), which is an extreme example of (2) above. The invention is further applicable to systems employing different casting schemes for the service that users receive, e.g., unicasting, multicasting and broadcasting. In addition, the mechanism of the invention is applicable to both TDD and FDD based systems.

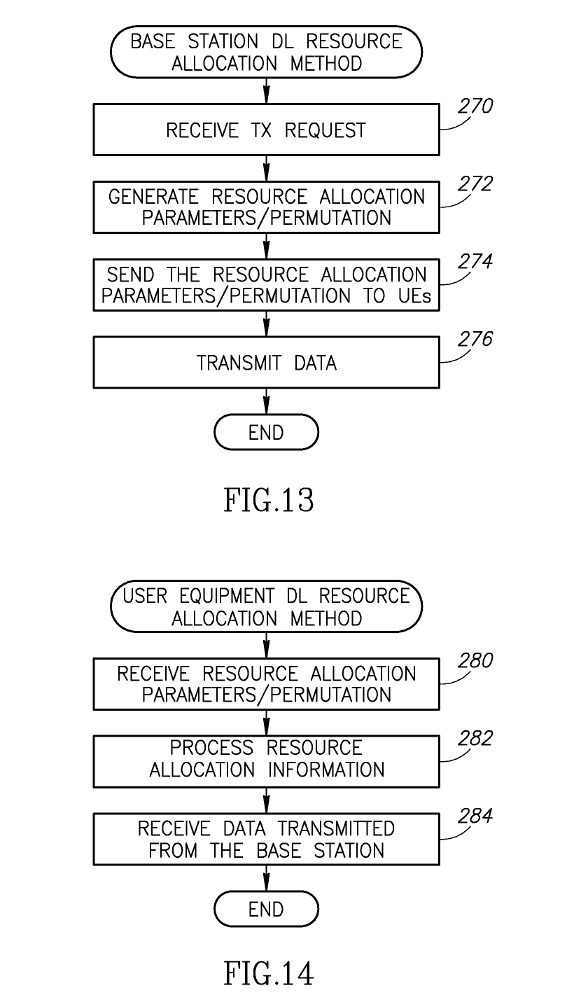

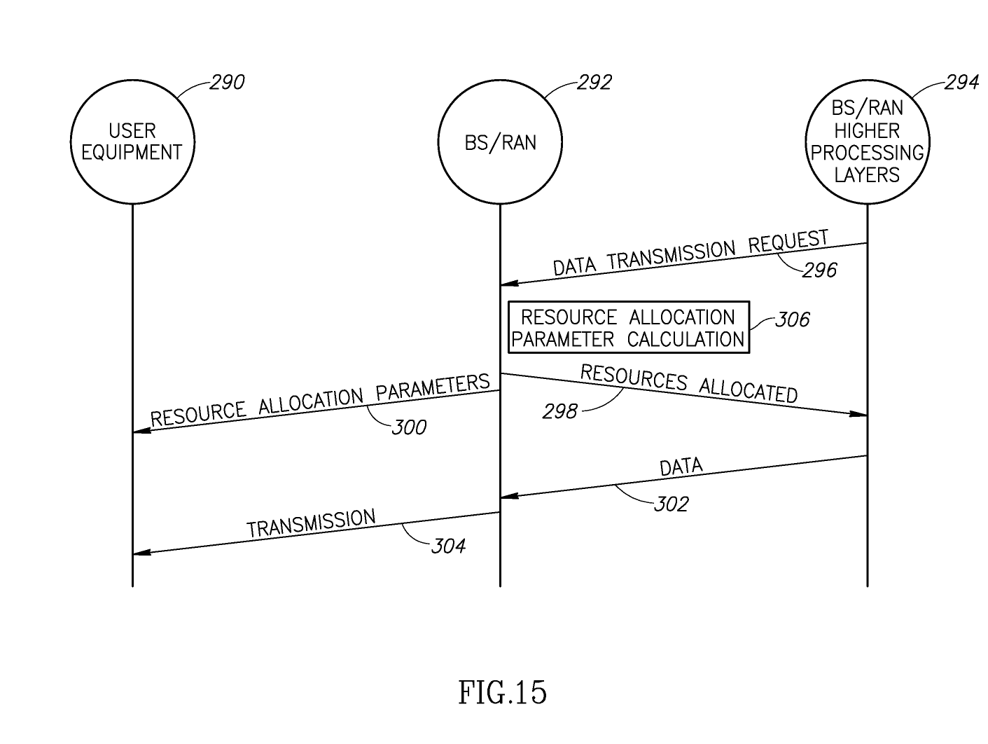

A flow diagram illustrating the base station DL resource allocation method of the present invention is shown in FIG. 13. A diagram illustrating an example protocol message flow for the DL is shown in FIG. 15 which details the message flow between the user equipment device 290, base station/RAN 292 and the base station/RAN higher processing layers 294. With reference to FIGS. 13 and 15, the base station receives a request to transmit 296 from the higher processing layers (step 270). In response, the resource allocation mechanism in the base station generates resource allocation parameters/permutation (block 306) (step 272). Note that the request serves to trigger the process or procedure of randomized resource allocation. The generation of the basic permutation is not necessarily dependent on the request but may be cell-specific or frame number dependent. The resource allocation parameters/permutation 300 are sent to the user equipment device(s) and the resources allocated 298 are forwarded to the higher processing layers (step 274). The base station then begins DL data transmission 302/304 (step 276).

A flow diagram illustrating the user equipment DL resource allocation method of the present invention is shown in FIG. 14. With reference to FIGS. 14 and 15, the user equipment device receives the resource allocation parameters/permutation 300 from the base station (step 280). In response, the user equipment device configures its index generator with the received parameters to enable it to duplicate the allocation generated at the base station (step 282). The user equipment then begins reception of DL data 304 transmitted from the base station (step 284).

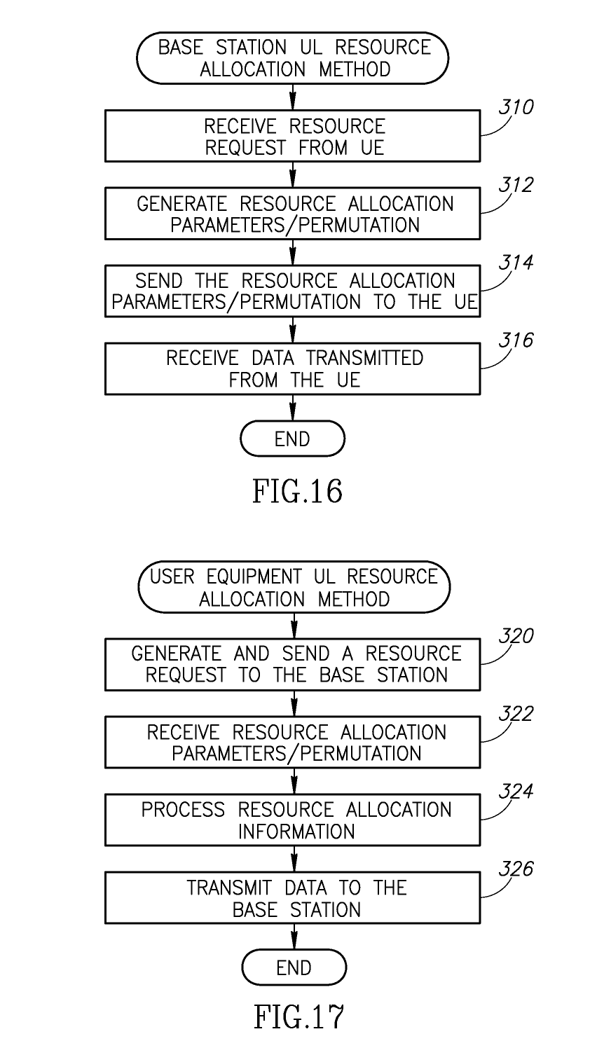

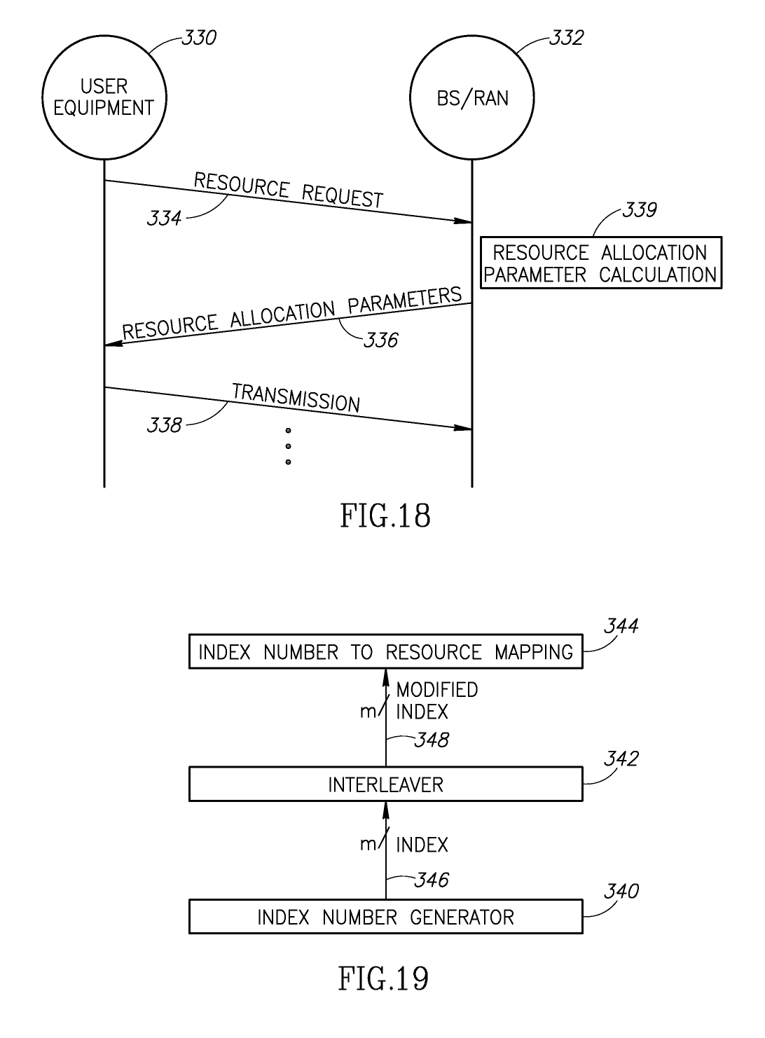

A flow diagram illustrating the base station UL resource allocation method of the present invention is shown in FIG. 16. A diagram illustrating an example protocol message flow for the UL is shown in FIG. 18 which details the message flow between the user equipment device 330 and the base station/RAN 332. With reference to FIGS. 16 and 18, the base station receives a resource request (resource request 334) from the user equipment (step 310). In response, the resource allocation mechanism in the base station generates resource allocation parameters/permutation (block 339) (step 312). The resource allocation parameters/permutation are sent (resource allocation parameters 336) to the user equipment device(s) (step 314). The base station then begins reception of UL data (transmission 338) from the user equipment device (step 316).

A flow diagram illustrating the user equipment UL resource allocation method of the present invention is shown in FIG. 17. With reference to FIGS. 17 and 18, the user equipment device generates and sends a resource request 334 to the base station (step 320). The base station generates the resource allocation parameters/permutation 336 (block 339) and sends them to the user equipment device (step 322). In response, the user equipment device configures its index generator with the received parameters to enable it to duplicate the allocation generated at the base station (step 324). The user equipment then begins transmission of UL data 338 to the base station (step 326).

### Modifying the Initial Allocation Sequence Generated

From the perspective of the network, a single allocation sequence may not suffice for the case of a network where the frequency re-use factor is one (i.e. no frequency planning is applied). Moreover, there are cases where it is required to increase the size of the randomized sequence for reasons other than the use of networks not employing any frequency planning. One example is the case where the cellular system decides to increase the available bandwidth. Therefore, to accommodate these situations the invention provides a mechanism for extending the basic permutation sequence to a sufficiently large set of sequences. The size of the sequence set is increased using any suitable technique. Several examples of multiplying factors that can be used to increase the sequence set size are provided below. Note that each may be used by itself or combined with one or more other factors.

1. Multiple sequences (i.e., GF(2^{m}) primitive polynomials).

2. Relative shift in a specific sequence (i.e., seed ‘rolling’).

3. Relative shifting of the physical resource map (i.e., time shift, frequency shift or combination of both). Note that this is a special case of re-indexing described in ‘Factor 4’ below.

4. Different methods of indexing the physical resource. Note that this factor may also be termed ‘renumbering or re-indexing the resource plan.’ The renumbering which indicates a logical resource to physical resource mapping may include, for example, flipping the indices from left to right, flipping the indices from up to down, or any other combination of flipping.

5. Interleaving the bits of the index to the allocated resource block. A diagram illustrating the generation of an index number using interleaved bits is shown in FIG. 19. In this example, interleaving of the index-number bits is used to generate the pseudo-random sequence. Thus, an interleaved version of the permutation bits used to generate a new permutation. The index number generator 340 generates an m-bit sequence 346 which is input to interleaver 342. The interleaver is operative to generate a modified m-bit index 348 which is used generate the resource mapping 344.

6. Use of longer permutations, thus generating longer sequences, with fewer bits masked to degenerate the sequence to a shorter one.

7. Concatenation of several shorter permutations to generate a larger sequence.

8. Using a multiple permutation approach with several different permutations, wherein each permutation is applied serially each applied to the output of another or in parallel wherein all permutations are combined before being applied to the output of the index generator.

9. Use of binary trees for the permutation generation, e.g., Orthogonal Variable Spreading Factor (OVSF) sequences.

10. Permutations based on a look up table (LUT).

11. Use of the GSM frequency hopping sequence as an index generator for the current multi-dimensional resource allocation system.

Several examples of the above sequence multiplication-factors are provided hereinbelow. In one embodiment of the invention, numbers exceeding 240 are discarded (corresponding to the 8-bit index generator example presented herein). In another embodiment, 15 other arbitrarily-chosen indices are discarded. In yet another embodiment, the numbers are biased with a fixed bias for a specific cell but change from cell to cell. Using a bias requires taking the resulting number pi and correcting it as follows.

qᵢ=((pᵢ+b)modulo N_{f}^{RF}*Nₜ^{RB})+1 (1)

where

pᵢ is the original index;

b denotes the bias;

qᵢ denotes the resulting biased index;

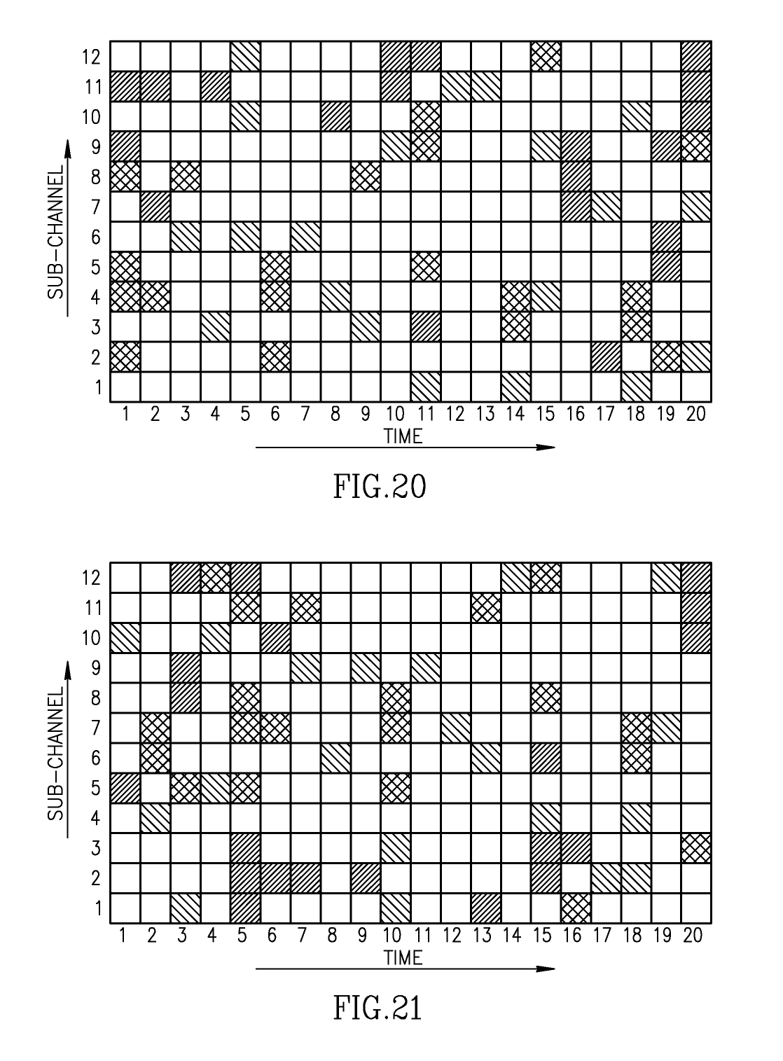

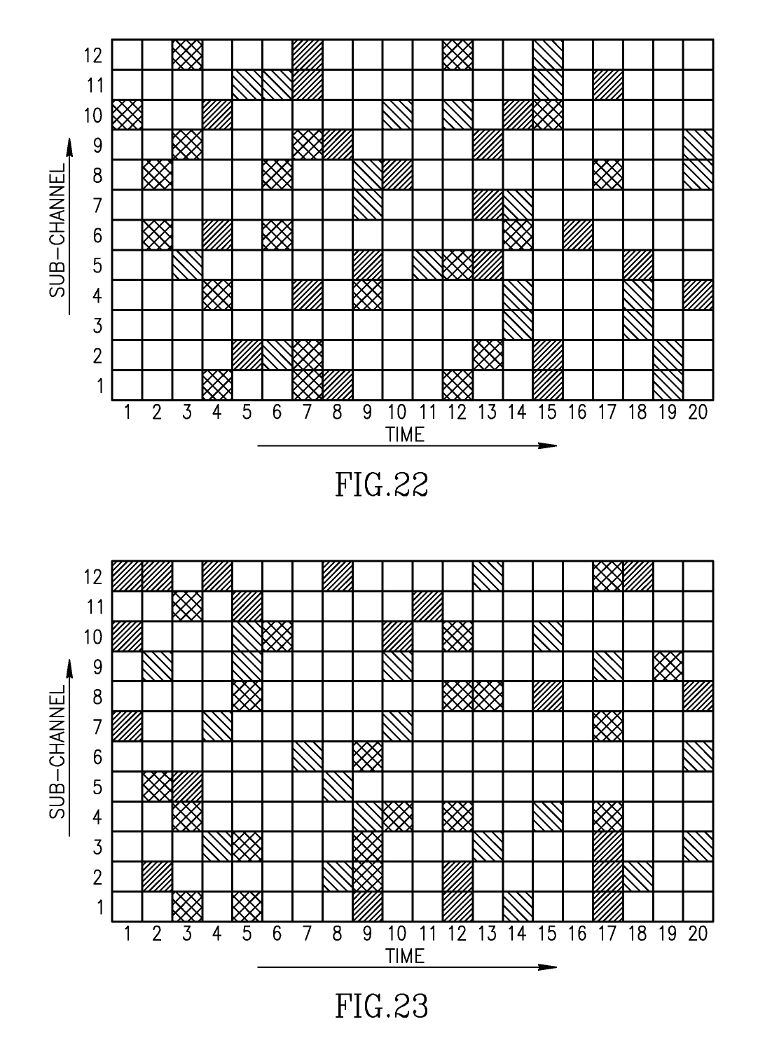

A resource allocation diagram illustrating a first example sequence allocation is shown in FIG. 20. A resource allocation diagram illustrating a first example sequence allocation where the index is shifted is shown in FIG. 21. A resource allocation diagram illustrating a first example sequence allocation where the sequence is shifted is shown in FIG. 22. A resource allocation diagram illustrating a second example sequence allocation is shown in FIG. 23. It is noted that these allocation diagrams are provided for illustration purposes only, as allocations of any desired size may be generated.

FIGS. 20, 21, 22, 23 each illustrate the resources allocated to three users wherein each user is assigned 20 resource blocks. The resources assigned to the three users are distinguished by the three types of hatching. User 1 allocation corresponds to the backward slanting hatching, user 2 allocation corresponds to the forward slanted hatching while user 3 allocation corresponds to the cross-hatching. In the allocation of FIG. 21, the indices are calculated in accordance with Equation 1 with bias b=51. In the allocation of FIG. 22, the sequences are shifted by 50 with respect to the original LFSR state by ‘rolling’ the LFSR 50 steps ahead. In the allocation of FIG. 23, a different primitive polynomial is used defined by the feedback taps 1, 6, 7 and 8.

The LFSR used to generate the resource allocations of FIGS. 20, 21, 22, 23 is LFSR 240 (FIG. 9) described supra. Table below shows the allocation indices generated for each user corresponding to the setup resulting in the allocation pattern depicted in FIG. 20.

TABLE 1
Original sequence #1 index generation

| | | |
|---|---|---|
| User 1 | User 2 | User 3 |

| Original | Ordered | Original | Ordered | Original | Ordered |
|---|---|---|---|---|---|
| 54 | 30 | 19 | 9 | 5 | 2 |
| 155 | 39 | 9 | 11 | 130 | 4 |
| 205 | 54 | 132 | 19 | 65 | 5 |
| 230 | 58 | 194 | 23 | 32 | 8 |
| 121 | 60 | 225 | 47 | 16 | 16 |
| 60 | 78 | 240 | 94 | 8 | 32 |
| 30 | 88 | 120 | 119 | 4 | 62 |
| 143 | 99 | 188 | 120 | 2 | 64 |
| 199 | 117 | 222 | 123 | 129 | 65 |
| 99 | 121 | 239 | 132 | 64 | 104 |
| 177 | 143 | 119 | 187 | 160 | 125 |
| 88 | 155 | 187 | 188 | 208 | 129 |
| 172 | 157 | 221 | 189 | 104 | 130 |
| 214 | 172 | 238 | 194 | 180 | 159 |
| 235 | 177 | 123 | 221 | 218 | 160 |
| 117 | 199 | 189 | 222 | 237 | 180 |
| 58 | 205 | 94 | 225 | 125 | 207 |
| 157 | 214 | 47 | 238 | 62 | 208 |
| 78 | 230 | 23 | 239 | 159 | 218 |
| 39 | 235 | 11 | 240 | 207 | 237 |

Each user sequence is represented by two columns (for a total of six) wherein each left user column lists the randomized indices generated originally and each right user column lists the same indices ordered in numerically ascending order. For user 1, for example, the first allocation resource block index calculated by the LFSR is 54 followed by 155, 205, 230 and so on. Indices exceeding 240 are discarded in this example. The ordered list of indices is calculated once the 20 user 1 resource blocks are allocated indices.

The first index calculated by the LFSR for user 2 is 19, which follows user 1's last index allocated 39. It is noted, however, that each user receives via control signaling its corresponding initial state of the LFSR and therefore is not aware of the existence of other users using a similar LFSR in the serving cell. Indices to user 3's 20 resource blocks are generated in similar fashion to that of users 1 and 2.

It is note that the original sequence generated for the three users is not ordered numerically. Therefore, optionally, systems may apply some type of ordering. Regardless of the resource allocation ordering, the resulting per-user resource allocation does not change.

The resource allocation permutations depicted in FIG. 20, 21, 22, 23 illustrate that changing the parameters causes substantial changes in the allocations patterns. For example, parameter modification may include (1) biasing of the physical resource indices, (2) shifting the sequence index, and (3) using a different LFSR feedback pattern (i.e. using a different m-sequence having the same length).

Tables 2, 3 and 4, presented below, corresponding to the allocation diagrams of FIGS. 21, 22 and 23, respectively, illustrate the list of indices output by the sequence generating apparatus. In particular, Table 2 shows the list of sequence #1 indices generated using a physical resource block offset of 51 relative to the list of indices generated in Table 1. Table 3 shows the list of sequence #1 indices generated using sequence shifting of 50, i.e. the LFSR is ‘rolled’ an additional 50 times. Table 4 shows the resource allocation list generated using a different LFSR as compared to Tables 1, 2 and 3.

TABLE 2
Sequence #1 index generation with physical resource block offset of 51

| | | |
|---|---|---|
| User 1 | User 2 | User 3 |

| Original | Ordered | Original | Ordered | Original | Ordered |
|---|---|---|---|---|---|
| 105 | 10 | 70 | 5 | 56 | 18 |
| 206 | 16 | 60 | 32 | 181 | 19 |
| 16 | 25 | 183 | 33 | 116 | 29 |
| 41 | 41 | 5 | 36 | 83 | 48 |
| 172 | 46 | 36 | 49 | 67 | 53 |
| 111 | 81 | 51 | 50 | 59 | 55 |
| 81 | 90 | 171 | 51 | 55 | 56 |
| 194 | 105 | 239 | 60 | 53 | 59 |
| 10 | 109 | 33 | 62 | 180 | 67 |
| 150 | 111 | 50 | 70 | 115 | 83 |
| 228 | 129 | 170 | 74 | 211 | 113 |
| 139 | 139 | 238 | 98 | 19 | 115 |
| 223 | 150 | 32 | 145 | 155 | 116 |
| 25 | 168 | 49 | 170 | 231 | 155 |
| 46 | 172 | 174 | 171 | 29 | 176 |
| 168 | 194 | 240 | 174 | 48 | 180 |
| 109 | 206 | 145 | 183 | 176 | 181 |
| 208 | 208 | 98 | 238 | 113 | 210 |
| 129 | 223 | 74 | 239 | 210 | 211 |
| 90 | 228 | 62 | 240 | 18 | 231 |

TABLE 3
Sequence #1 index generation with sequence shifting of 50

| | | |
|---|---|---|
| User 1 | User 2 | User 3 |

| Original | Ordered | Original | Ordered | Original | Ordered |
|---|---|---|---|---|---|
| 160 | 29 | 209 | 42 | 74 | 10 |
| 208 | 59 | 232 | 46 | 37 | 18 |
| 104 | 62 | 116 | 50 | 146 | 20 |
| 180 | 71 | 186 | 76 | 73 | 33 |
| 218 | 103 | 93 | 83 | 36 | 36 |
| 237 | 104 | 46 | 84 | 18 | 37 |
| 125 | 118 | 151 | 85 | 137 | 40 |
| 62 | 125 | 203 | 93 | 68 | 66 |
| 159 | 142 | 101 | 101 | 162 | 68 |
| 207 | 159 | 50 | 116 | 81 | 73 |
| 103 | 160 | 153 | 149 | 40 | 74 |
| 179 | 163 | 76 | 151 | 20 | 81 |
| 217 | 179 | 166 | 153 | 10 | 100 |
| 236 | 180 | 83 | 166 | 133 | 133 |
| 118 | 207 | 169 | 169 | 66 | 137 |
| 59 | 208 | 84 | 170 | 33 | 144 |
| 29 | 217 | 170 | 186 | 144 | 146 |
| 142 | 218 | 85 | 203 | 200 | 162 |
| 71 | 236 | 42 | 209 | 100 | 178 |
| 163 | 237 | 149 | 232 | 178 | 200 |

TABLE 4
Original sequence #2 index generation

| | | |
|---|---|---|
| User 1 | User 2 | User 3 |

| Original | Ordered | Original | Ordered | Original | Ordered |
|---|---|---|---|---|---|
| 234 | 21 | 10 | 7 | 225 | 17 |
| 117 | 39 | 133 | 10 | 112 | 25 |
| 58 | 43 | 194 | 12 | 56 | 28 |
| 157 | 57 | 97 | 14 | 28 | 35 |
| 206 | 58 | 176 | 24 | 142 | 49 |
| 231 | 78 | 216 | 29 | 199 | 51 |
| 115 | 86 | 236 | 48 | 99 | 56 |
| 57 | 89 | 118 | 59 | 49 | 70 |
| 156 | 100 | 59 | 96 | 152 | 98 |
| 78 | 115 | 29 | 97 | 204 | 99 |
| 39 | 117 | 14 | 118 | 102 | 102 |
| 147 | 147 | 7 | 131 | 51 | 112 |
| 201 | 156 | 131 | 133 | 25 | 136 |
| 100 | 157 | 193 | 134 | 140 | 140 |
| 178 | 172 | 96 | 176 | 70 | 142 |
| 89 | 178 | 48 | 193 | 35 | 152 |
| 172 | 201 | 24 | 194 | 17 | 196 |
| 86 | 206 | 12 | 195 | 136 | 199 |
| 43 | 231 | 134 | 216 | 196 | 204 |
| 21 | 234 | 195 | 236 | 98 | 225 |

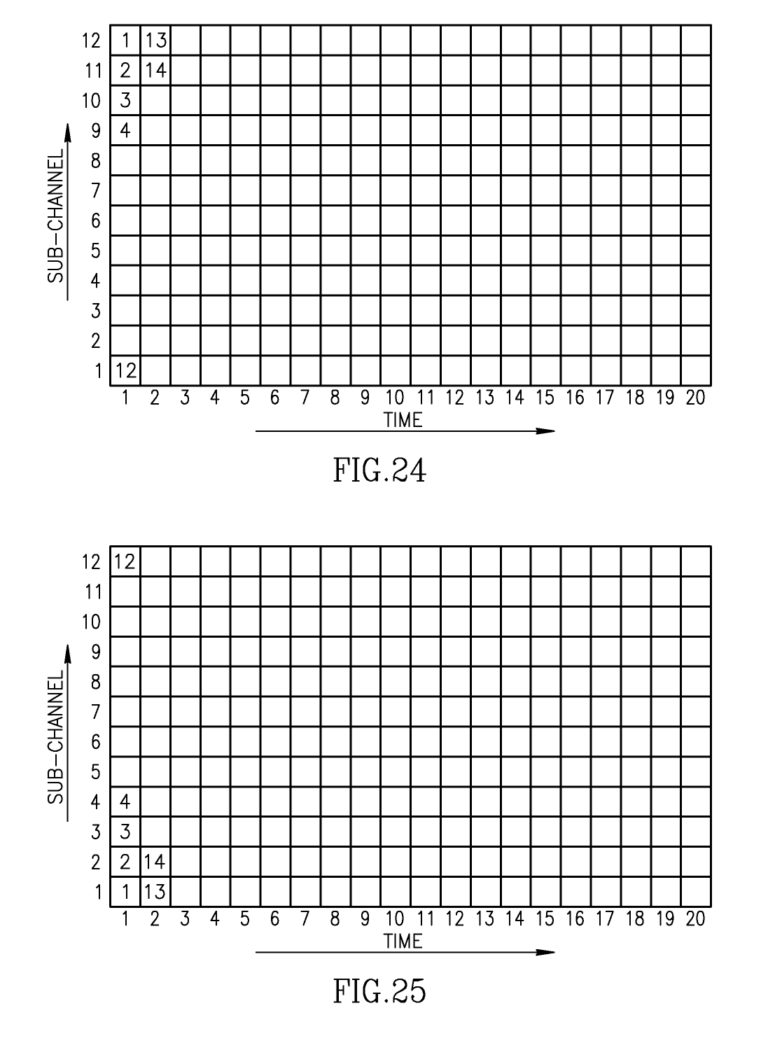

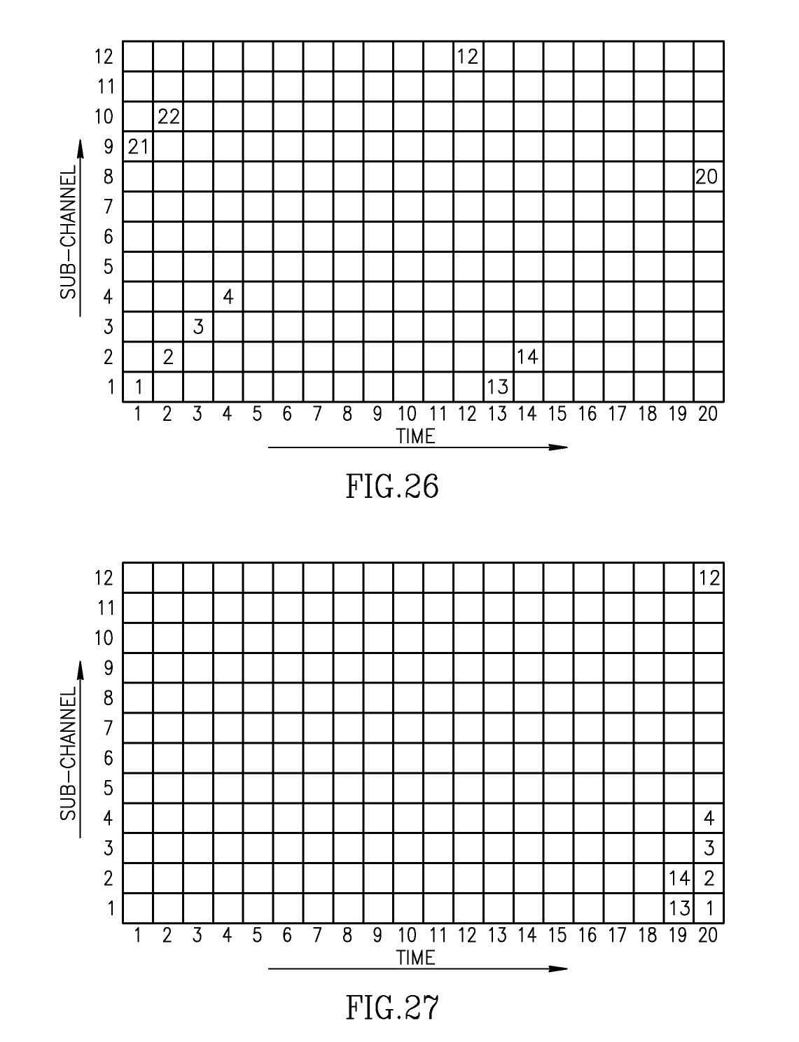

FIGS. 24, 25, 26, 27 depict four example approaches to accessing cell resources. The allocation diagram of FIG. 24 shows an original resource allocation wherein the resources are numbered starting from the left upper corner first in up/down fashion and then from left to right. FIG. 25 shows the allocation of FIG. 24 flipped upside down, while FIG. 27 shows the allocation of FIG. 25 flipped left to right (i.e. a combined flipped upside down and left to right version of the allocation of FIG. 24). FIG. 26 illustrates a diagonal form of resource numbering.

It is intended that the appended claims cover all such features and advantages of the invention that fall within the spirit and scope of the present invention. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention.

What is claimed is:

1. A method of allocating resources for communication with a plurality of user equipment (UE) in a wireless communications system, said method comprising the step of:
generating a randomized resource allocation permutation;
assigning resources for communication with said plurality of UE in accordance with said resource allocation permutation; and
communicating information to said plurality of UE to enable duplication of said resource allocation permutation therein.

2. The method according to claim 1, wherein said randomized allocation permutation is generated utilizing a polynomial.

3. The method according to claim 1, wherein a polynomial is used to generate said randomized allocation permutation wherein a different set of parameters, each defining a different polynomial, is used for each cell.

4. The method according to claim 1, wherein said randomized allocation permutation is generated utilizing a look up table.

5. The method according to claim 1, wherein said randomized allocation permutation is generated utilizing a linear feedback shift register (LFSR).

6. The method according to claim 1, wherein said randomized allocation permutation is expanded using multiple permutations.

7. The method according to claim 1, wherein said randomized allocation permutation is expanded by applying a relative shift to a permutation.

8. The method according to claim 1, wherein said randomized allocation permutation is expanded by re-indexing an associated physical resource map.

9. The method according to claim 1, wherein said randomized allocation permutation is expanded by interleaving bits of an index to an allocated resource block.

10. The method according to claim 1, wherein said randomized allocation permutation is expanded using longer permutations and masking one or more bits to shorten the resultant permutation.

11. The method according to claim 1, wherein said randomized allocation permutation is expanded using binary trees in the generation of said permutation.

12. The method according to claim 1, wherein said randomized allocation permutation is expanded by using a frequency hopping sequence as a permutation index generator.

13. The method according to claim 1, wherein a unique permutation used in a cell is identified using one or more parameters known to both base station and UE.

14. A method of allocating resources for communication with a plurality of user equipment (UE) for use in a base station in a cellular communications system, said method comprising the step of:
receiving a request to transmit;
in response to said request, generating a randomized resource allocation based on a permutation generated in accordance with said cellular system;
assigning resources for communication with said plurality of UE in accordance with said resource allocation permutation;
communicating information to said plurality of UE to enable duplication of said resource allocation permutation therein; and
transmitting to said plurality of UE wherein data for each UE is allocated in accordance with said resource allocation permutation.

15. The method according to claim 14, wherein a unique permutation used in a cell is identified using one or more parameters known to both base station and UE.

16. A method of allocating resources for communication with a base station for use in a user equipment (UE) in a wireless communications system, said method comprising the step of:
sending a resource request to said base station;
receiving from said base station, in response to said resource request, parameters to enable duplication of a randomized resource allocation permutation generated by said base station and used to assign resources for communication in said wireless communications system; and
transmitting to said base station wherein data is allocated in accordance with said resource allocation permutation.

17. The method according to claim 16, wherein a unique permutation used in a cell is identified using one or more parameters known to both base station and UE.

18. A resource allocation apparatus for use in a cellular communications system, comprising:
an index generator operative to generate a randomized resource allocation permutation; and
a resource allocation module operative to assign resources for communication with a plurality of UE in accordance with said resource allocation permutation and to communicate information to said plurality of UE thereby enabling duplication of said resource allocation permutation therein.

19. The apparatus according to claim 18, wherein a unique permutation used in a cell is identified using one or more parameters known to both base station and UE.

20. The apparatus according to claim 18, wherein said randomized allocation permutation is generated utilizing a polynomial.

21. The apparatus according to claim 18, wherein said randomized allocation permutation is generated utilizing a linear feedback shift register (LFSR).

22. The apparatus according to claim 18, wherein each cell in said communication system is assigned its own allocation permutation.

23. The apparatus according to claim 18, wherein each plurality of cells having joined resources is assigned its own allocation permutation.

24. A communications device, comprising:
a transmitter;
a receiver;
a media access control (MAC);
a baseband processor coupled to said transmitter, said receiver and said MAC;
a resource allocation unit for communicating with a base station, said resource allocation unit operative to:
send a resource request to said base station;
receive from said base station, in response to said resource request, parameters to enable duplication of a randomized resource allocation permutation generated by said base station and used to assign resources for communication therebetween; and
transmitting to said base station wherein data is allocated in accordance with said resource allocation permutation.

25. The communications device according to claim 24, wherein a unique permutation used in a cell is identified using one or more parameters known to both base station and UE.
